(19) United States
(12) Patent Application Publication
(10) Pub. No.: US 2026/0302784 A1
(43) Pub. Date: Oct. 1, 2026

(54) LONG-DURATION ENERGY STORAGE SYSTEM

(71) Applicant: NOON ENERGY, INC., Palo Alto, CA (US)

(72) Inventors: Sunjay G. MELKOTE, Sunnyvale, CA (US); Pawel A. Piotrowicz, Santa Clara, CA (US); Christopher Ronald Graves, Palo Alto, CA (US); Theis L. Skafte, Palo Alto, CA (US); Frank John Luciano, IV, Menlo Park, CA (US); Lyndsey Rose Shuckerow, Sunnyvale, CA (US)

(21) Appl. No.: 19/578,590

(22) Filed: Mar. 25, 2026

Related U.S. Application Data
(60) Provisional application No. 63/777,524, filed on Mar. 25, 2025.
(60) Provisional application No. 63/885,887, filed on Sep. 22, 2025.

(51) Int. Cl. H02J 3/28; G06Q 50/06; H01M 8/18; H02J 3/00; H02J 3/38; H02J 3/466; H02J 101/24; H02J 101/30; H02J 101/35; H02J 103/30

(52) U.S. Cl. CPC H02J 3/28; G06Q 50/06; H01M 8/188; H02J 3/003; H02J 3/004; H02J 3/381; H02J 3/466; H02J 2101/24; H02J 2101/30; H02J 2101/35; H02J 2103/30

(57) ABSTRACT

Set forth herein are long duration energy storage systems that include at least two kinds of subsystems, one being a long duration subsystem such as, but not limited to, a reversible solid-oxide electrochemical fuel cell/electrolyzer and the other being a buffer system such as, but not limited to, a rechargeable lithium battery. Also set forth herein are processes of making and using these systems.

### CROSS-REFERENCE TO RELATED APPLICATIONS

The application claims priority to, and the benefit of, U.S. Provisional Patent Application No. 63/777,524, filed Mar. 25, 2025, and U.S. Provisional Patent Application No. 63/885,887, filed Sep. 22, 2025, the entire contents of each of which are herein incorporated by reference in their entirety for all purposes.

### FIELD

The present disclosure concerns energy storage systems. These systems include a long duration energy storage subsystem, such as, but not limited to, a stack of reversible solid-oxide electrochemical cells. These systems also include a buffer subsystem. The buffer subsystem can have a higher power capacity and/or discharge C-rate but a lower energy capacity than the long duration energy storage subsystem.

### BACKGROUND OF THE INVENTION

Long duration energy storage systems are in great demand. These systems are necessary to make intermittent renewable energy generation sources like solar and wind viable alternatives to combustion-based energy generation when adequate sun or wind is not available. However, current energy storage systems are economically prohibitive for large scale installations and/or lack the ability to store and adequately discharge electrical energy at power that sufficiently matches load demands.

Certain energy storage systems are known, such as (1) Hutty, T. D., Dong, S. and Brown, S., Suitability of Energy Storage with Reversible Solid Oxide Cells for Microgrid Applications, Energy Conversion and Management 226 (2020), https://doi.org/10.1016/j.enconman.2020.113499; (2) Liu, T., Yang, Z., Duan, and Y. Short, Long-Duration Cooperative Energy Storage System: Optimizing Sizing and Comparing Rule-based Strategies, Energy 281 (2023), https://doi.org/10.1016/j.energy.2023.128273; (3) Cárdenas, B., Swinfen-Styles, L., Rouse, J. and Garvey, S. D., Short-, Medium-, and Long-Duration Energy Storage in a 100% Renewable Electricity Grid: A UK Case Study, Energies 14 (2021), https://doi.org/10.3390/en14248524; (4) Bocklisch, T., Hybrid Energy Storage Systems for Renewable Energy Applications, Energy Procedia 73, 103-111 (2015), https://doi.org/10.1016/j.egypro.2015.07.582; and (5) Chong, L. W., Wong, Y. W., Rajkumar, R. K., Rajkumar, R. K., and Isa, D. Hybrid Energy Storage Systems and Control Strategies for Stand-alone Renewable Energy Power Systems. Renewable and Sustainable Energy Reviews 66, 174-189 (2016), https://doi.org/10.1016/j.rser.2016.07.059. See also US Patent Application Publication Nos. 2020/0136153, US20180191005A1, and US2020/0136153A1; and U.S. Pat. Nos. 11,949,134 B2, 11,817,605 B2. The entire contents of each of these publications are herein incorporated by reference in their entirety for all purposes. However, these disclosures suffer from a variety of deficiencies that render them commercially unviable for long term energy storage applications.

What is needed are renewable long duration energy storage systems that provide electrical energy for hours, days, weeks, or even months and that can ramp output power gradually to meet demand loads. What is needed are renewable long duration energy storage systems that allow for seasonal shifting and that accommodate changes in solar and wind availability for electrical power generation. What is needed are long duration energy storage systems that include modular power components and energy components that can be cross-charged, appropriately sized, and combined for different applications. What is needed are long duration energy storage systems that can be optimized for round trip efficiencies and combined in ways that reduce the cost to deploy these systems at scale. What is needed are extended networks of long duration energy storage systems that can be optimized to transfer charged and discharged media between installations to take advantage of certain geographic locations that have larger renewable energy generating capacity compared to other locations.

Set forth herein are solutions to these problems as well as others known in the field to which the instant disclosure pertains.

### SUMMARY OF THE INVENTION

In one embodiment, set forth herein is an energy storage system (ESS) that includes a long duration subsystem (LDS) configured for cross-charging with a buffer subsystem (BSS); and at least one processor for controlling series flow, parallel flow, charge C-rates, discharge C-rates, power electronics, or a combination thereof. The ESS has a charge-to-discharge power ratio (c/d) of 1 to 10.

In another embodiment, set forth herein is a method of using an ESS, wherein the method includes providing a LDS configured for cross-charging with a BSS; and providing at least one processor for controlling series flow, parallel flow, charge C-rates, discharge C-rates, power electronics, or a combination thereof; inputting supply load data, demand load data, ancillary data, or a combination thereof into the at least one processor; and sending instructions from the at least one processor to the LDS, BSS, power electronics, or both, to charge or discharge the LDS, BSS, or both the LDS and BSS.

Also set forth herein is an operation algorithm for controlling an ESS, in which controlling includes charging or discharging the ESS. Controlling also includes coproducing chemicals and fuels in conjunction with electrical power generation or storage, or refueling the ESS for additional electrical power generation using an external source of charged media.

Also set forth herein is an energy storage network (ESN), that includes at least two energy storage systems (ESS); and configured to: (a) transport charge media between the at least two ESS; (b) transport discharge media between the at least two ESS; or a combination of (a) and (b).

Also set forth herein is a method of using an energy storage system (ESS), that includes providing an ESN described herein; and (a) transporting charge media between the at least two ESS; (b) transporting discharge media between the at least two ESS; or a combination of (a) and (b).

### BRIEF DESCRIPTION OF DRAWINGS

FIG. 1 shows a logical flow diagram describing the flow of information and energy between power subsystems (i.e., the Buffer units) and energy subsystems (i.e., the LDS units), power electronics, decision maker, and external loads.

FIG. 2 is a diagram detailing how a decision maker/controller classifies scenarios based on state-of-charge, load, and subsystem power capacities.

FIG. 3 shows examples of how a decision maker uses classified scenarios to determine an operating mode to use.

FIG. 4 shows cost-optimal system duration, which is defined as the ratio of energy capacity to power capacity, as a function of the degree of energy movement in series mode as a proportion of total energy discharged, compiled over several optimizations with varying conditions.

FIG. 5 shows a case study showing cost-optimal system sizes both with and without series operation (322 hours and 424 hours, respectively) for an islanded system that uses solar energy in an embodiment of an energy storage system (ESS) during a representative year. Time (hour of year) is on the x-axis and state-of-charge (expressed as hours of duration remaining) is on the y-axis. This figure was prepared by performing optimization simulations (as described for FIG. 4) at a single location. The decision maker varied to allow series energy flow (cross-charging) in the first run and not allow it (only parallel energy flow) in the second.

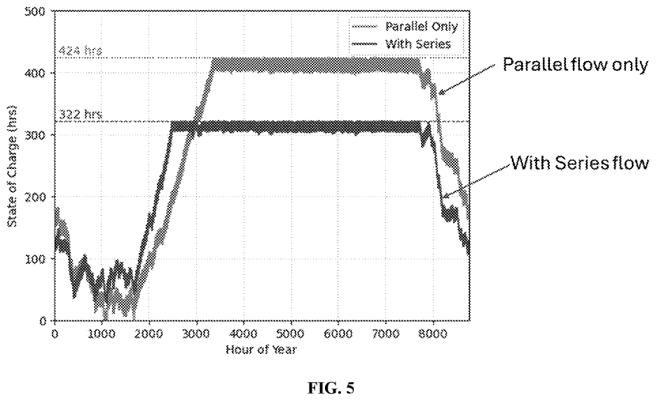

FIG. 6 demonstrates the tradeoff between system cost (left axis) and round-trip efficiency (RTE, right axis) when implementing series charging into a control scheme.

FIG. 7 displays systems meeting a set net load-difference between solar supply (positive) and demand (negative)-using only parallel operation (top left) and with the option of series operation (top right).

FIG. 8 is a representation of co-production with different system configurations. The representation shows the ability to fill excess storage vessels with chemical fuels produced by the system and was calculated through time-series computation.

FIG. 9 is a representation of an energy storage system operation embodiment with multiple power modules that provide buffer operation. There are eight power systems (labelled “RSOC system”). The red line is a representative charge profile throughout an example day. A control algorithm operates each subsystem for a specific amount of time to minimize idling. The buffer subsystems fill in gaps between LDS operation and the load.

FIG. 10 is an illustration of an embodiment of long duration energy storage location shifting between two geographic locations, one of which has more renewable energy generating capacity than the other.

FIG. 11 is an illustration of an embodiment of long duration energy storage location shifting between two geographic locations, one of which has more renewable energy generating capacity than the other, and in which both locations are grid-connected.

FIG. 12 is an illustration of an embodiment of long duration energy storage location shifting between two geographic locations, one of which has renewable energy generating capacity and the other location does not but is grid-connected.

FIG. 13 is an illustration of an embodiment of long duration energy storage location shifting between two geographic locations one of which has renewable energy generating capacity and the other location does not.

### DETAILED DESCRIPTION OF THE INVENTION

Described herein are rechargeable long-duration energy storage systems. These systems are useful for applications that require large energy storage over extended durations, such as those that provide power capacity exceeding about six hours. The systems set forth herein can reversibly store and release energy. In some embodiments, these systems are closed systems that store and release electrical energy without incorporating external chemical reactants or discharging chemical products. In other embodiments, these systems are open systems that coproduce chemical fuels electrochemically or that incorporate external chemical fuel to refuel the electricity generating subsystems in addition to using fuels contained within the system. In some embodiments, these systems can switch from being a closed system to an open system. These systems combine one or more high energy-capacity subsystem(s) that may have a lower C-rate with one or more high power-capacity subsystem(s) that may have a higher C-rate. The systems herein operate with a novel control scheme that optimizes system performance. This optimization allows (a) each subsystem to be smaller than they would need to be to provide the same energy or power, (b) the overall system to be more cost-effective than each subsystem if each subsystem were deployed in isolation, and (c) round-trip efficiency (RTE) of the entire system to be between the RTE of each subsystem. In some embodiments herein, a buffer subsystem that has a cheaper power capacity but a faster ability to ramp power output is paired with a long duration subsystem that has a cheaper energy capacity but is less able to ramp power output quickly. In certain embodiments, the buffer operating capacity is less than twenty-four hours or less than eight hours and the long duration subsystem has an operating capacity greater than twenty-four hours.

As used herein, “cross-charging” and “series flow” are used synonymously. Series flow refers to the conduction of current from an LDS to a BSS or from a BSS to an LDS. In series flow, energy is transferred from one subsystem to another subsystem in the ESS. By contrast, parallel flow refers to discharging or charging an LDS independently of a BSS. For example, in parallel flow, current may conduct from, or to, the LDS and an external circuit without conducting through the BSS. Also, for example, in parallel flow current may conduct from, or to, the BSS and an external circuit without conducting through the LDS. In parallel flow, one component of the ESS could be charging while the other component is discharging. For example, in one embodiment of an ESS, the LDS could be charging while the BSS is discharging. In another embodiment of an ESS, the LDS could be discharging while the BSS is charging. In parallel flow, each subsystems can simultaneously charge and/or discharge to meet energy loads. Importantly, each subsystem (and/or unit within each subsystem) can operate at different power levels. In an extreme condition, one subsystem can idle (operating power is zero) while the other handles the entire load. In series flow, energy is passed either between units in a subsystem or from one subsystem to another. This way each subsystem/unit can share charge and the LDS subsystem can carry the bulk of the energy while the BSS subsystem can handle large swings in power load.

As used herein, the phrase, “coproduction” refers to the use of electricity generated by an LDS or BSS, herein, to form a chemical product or chemical fuel. This includes using an LDS, BSS, or both, here, to make excess charge storage media and export that charge storage media outside the system. “Coproduction” includes, but is not limited to, making a coproduced fuel that may be different from the charge media that is stored within the LDS, and/or used within the LDS for producing electricity. For example, “coproduction,” includes producing charge storage media that is exported, or even in some embodiments producing a different chemical than its storage media by carrying out electrolysis on externally supplied oxidized chemicals. Also, for example, the LDS or BSS may generate electricity that is used to reduce CO₂ and H₂O to form CH₄ and O₂. In other embodiments, an LDS or BSS may generate electricity that is used to reduce CO₂ and H₂O to form CH₄, H₂, O₂, methanol or other fuels. Coproduction includes, in some embodiments, switching the ESS from a closed system to an open system so that the produced chemical or fuel can be externally stored or transported. Coproduction also includes the use of externally supplied electricity to operate an rSOC LDS unit as an electrolyzer to produce chemicals and/or chemical fuels.

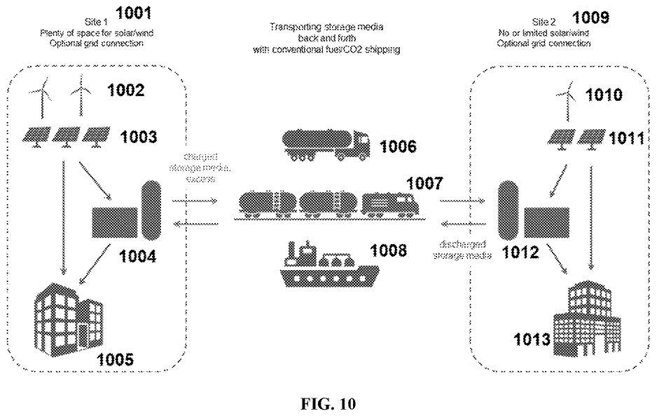

As used herein, the phrase, “refueling” refers to the use of an external charged media source to supply charged media (i.e., fuel) to the LDS, such as an rSOC, to generate electricity. This includes switching the ESS from a closed system to an open system so that the externally stored or transported charged media can enter the otherwise closed ESS system. Non-limiting examples of externally storing and transporting are shown in FIGS. 10-13 and the associated descriptions. In certain embodiments, the ESS has charged media contained within the closed system. However, if more energy is needed than can be provided with that contained (i.e., stored) charged media, an external source of fuel may be used to refuel the system. Herein, fuel may refer to charge media. Charge media is fuel useful for charging the ESS or a subsystem thereof. Charge media can also be used to generate electricity in an rSOC. Discharge media is produced by the ESS.

As used herein, “chemical media” is used to refer to a fuel that is used with a SOFC to generate electricity or products formed from oxidizing this fuel. Here, “charged storage media” and “discharged storage media” (or in certain embodiments “chemical media”) can be imported or exported from the system. Importing charged storage media that was produced in another ESS is one example of “refueling.” In some embodiments herein, in which the system comprises a fuel-flexible SOFC, “refueling” can also refer to the process of importing fuels such as hydrogen, methane, methanol, and ethanol, that are made from fossil, biomass, or electrofuel resources. Refueling may also include supplying hydrogen, natural gas, ethanol, methanol, propane, ammonia, hydrazine, or other fuels for solid oxide fuel cells from an external source. Herein, “exporting charged storage media” is an example of “co-production” of storage media, which can then be imported into another ESS (i.e., refueling it). In some other embodiments, exported storage media that is similar to or the same as such as hydrogen, methane, methanol, ethanol, and butanol, then it can be used as a fuel in other applications and/or sold in the fuel market.

As used herein, “operating capacity,” refers to the power output that the ESS is configured to provide. For example, if the ESS includes a nominal power rating of 100 kW LDS and a 50 kW BSS, the operating capacity would be the sum of these subsystems. In this example, this sum equals a nominal operating power capacity of 150 kW. These power ratings can peak at higher powers. For example, the BSS can peak at a higher power, such as, but not limited to, 250 kW or 5C, where nominal operation is 1 C.

As used herein, the phrase, “long duration subsystem (LDS),” refers to an energy storage system that has a higher energy capacity, but lower C-rate or power capacity, than a lower energy capacity module, that has a higher C-rate or power capacity, with which the LDS is electrically coupled or combined in an ESS. Similarly, a buffer subsystem (BSS) refers to an energy storage system that has a lower energy capacity, but higher C-rate or power capacity, than a higher energy capacity module, that has a lower C-rate or power capacity, with which the BSS is electrically coupled or combined in an ESS. As one non-limiting example, a stack of reversible solid-oxide electrochemical cells (rSOC) may be combined in an ESS with a series of lithium-ion batteries. The stack of rSOC has a larger energy capacity than the lithium-ion batteries but discharges that energy at much lower power than does the lithium-ion batteries. In this configuration, the stack of rSOC is the LDS and the lithium-ion batteries are the BSS.

As used herein, “flow batteries” refer to electrochemical systems where energy is stored and discharged using a flow mechanism to pass fuel or electrolyte between reservoirs. In some embodiments, a thermochemical system may be added ancillary to a flow battery system.

As used herein, “C-rate” refers to the rate at which an electrochemical device charges or discharges relative to its maximum capacity. C-rate is current divided by capacity; or C-rate=current (amperes, I)/capacity (amperes/hour, Ah). C-rate can be measured in the discharge mode, i.e., discharge C-rate, or charge mode, i.e., charge C-rate. A 1 C C-rate battery charges or discharges its maximum capacity in 1 hour. A 2 C C-rate battery charges or discharges its maximum capacity in 0.5 hour. A 3 C C-rate battery charges or discharges its maximum capacity in ⅓ hour. A C/10 C-rate battery charges or discharges its maximum capacity in 10 hours.

As used herein, the phrase, “charge-to-discharge power ratio (c/d),” refers to the ratio of power input when charging the ESS, the LDS, the BSS, or a combination thereof, relative to the power output when discharging the same. Power is the product of current and voltage. Therefore, if the current and voltage when charging the ESS is the same as the current and voltage when discharging the ESS, then the charge-to-discharge power ratio of the ESS is 1. On the other hand, if the mathematical product of current and voltage when charging the ESS is ten times as large as the product of current and voltage when discharging the ESS, the charge-to-discharge power ratio would be 10:1 or 10.

As used herein, the phrase, “average charge-to-discharge power ratio (c/d_{avg}),” refers to the charge-to-discharge power ratio, as defined above, calculated as an average over a time period, such as one hour, 12 hours, or 24 hours.

As used herein, the phrase, “peak charge-to-discharge power ratio (c/dₚₖ),” refers to a maximum charge-to-discharge power ratio measured over a time period, such as one hour, 12 hours, or 24 hours.

As used herein, the phrase, “energy capacity ratio,” refers to the ratio of total stored energy of one subsystem or module, such as the LDS, relative to the total stored energy of another subsystem or module, such as the BSS. Energy herein is referred to as capacity and defined by the units Watt-hours or Wh. For example, if an LDS has an energy capacity of 100 kWh and a BSS has an energy capacity of 50 kWh, then the energy capacity ratio would be 2:1 or 2.

As used herein, the phrase, “rSOC flow battery,” refers to a battery that operates by flowing a fuel into a solid oxide cell to generate electricity in fuel cell mode and that also operates by using electricity in a solid oxide cell to generate a fuel product in electrolyzer mode. The rSOC operates reversibly in fuel cell mode and in electrolyzer mode depending on whether electricity is flowing out of or into the solid oxide cell, respectively. An example rSOC flow battery is found in U.S. Pat. No. 11,876,269, PASSIVE FLOW BATTERY, which issued Jan. 16, 2024, the entire contents of which are herein incorporated by reference in its entirety.

As used herein, the phrase, “carbon-chemistry system,” refers to a solid oxide cell that operates in fuel cell mode to convert carbon (C) and oxygen (O₂) into carbon dioxide (CO₂) and generate electricity; and that operates in electrolyzer mode to convert CO₂ into C and O₂; and/or CO₂ into CO and O₂, and consume electricity.

As used herein, the phrase, “hydrogen-chemistry system,” refers to a solid oxide cell that operates in fuel cell mode to convert hydrogen (H₂) and oxygen (O₂) into water (H₂O) and generate electricity; and that operates in electrolyzer mode to convert H₂O into H₂ and O₂ and consume electricity.

As used herein, the phrase, “carbon-hydrogen-chemistry system,” refers to a solid oxide cell that operates in fuel cell mode to convert carbon, a hydrocarbon (e.g., CH₄), or an oxygenated hydrocarbon (e.g., CH₃OH, CH₃CH₂OH) and oxygen (O₂) into carbon dioxide (CO₂) and water (H₂O) and generate electricity; and that operates in electrolyzer mode to convert H₂O into H₂ and O₂; also CO₂ into CO and O₂; also CO₂ into C and O₂; and consume electricity. A variety of hydrocarbons may be used such. Herein, a carbon-hydrogen-chemistry system includes hydrocarbon chemistry systems generally, alcohol chemistry systems, and carbon-hydrogen chemistry systems, specifically. For example, a carbon-hydrogen chemistry system is one that is capable of reversibly reacting carbon dioxide and water to form methane and oxygen, e.g., CO₂+2H₂O↔CH₄+2O₂. Hydrocarbon systems include, but are not limited to, systems that reversibly react aromatic hydrocarbons, i.e., arenes, and saturated alicyclic hydrocarbons.

As used herein, the phrase, “ammonia-chemistry system,” refers to a solid oxide cell that operates in fuel cell mode to convert ammonia (NH₃) and oxygen (O₂) into nitrogen (N₂) and water (H₂O) and generate electricity; and that operates in electrolyzer mode to convert N₂ and H₂O into NH₃ and O₂ and consume electricity. Ammonia-chemistry systems also include a solid oxide cell that operates in fuel cell mode to convert ammonia (NH₃) into nitrogen (N₂) and hydrogen (H₂) and generate electricity; and that operates in electrolyzer mode to convert N₂ and H₂ into NH₃ and generate electricity.

As used herein, the phrase, “iron-chemistry system,” refers to a solid oxide cell that operates in fuel cell mode to convert iron oxide (Fe₃O₄) and hydrogen (H₂) into iron (Fe) and water (H₂O) and generate electricity; and that operates in electrolyzer mode to convert Fe and H₂O into Fe₃O₄ and H₂ and consume electricity. Iron-chemistry systems also include a solid oxide cell that operates to reversibly oxidize or reduce sodium iron sulfate compounds.

As used herein, the phrase “closed system” refers an energy storage system where no fuel enters or exits the battery. The only thing going in/out is electricity during charge/discharge and oxygen (O₂) from the atmosphere. O₂ enters during discharge mode and O₂ exits during charge mode. All of the chemical reagents and/or products, other than oxygen, are stored within a closed system.

As used herein, the phrase “open system” refers an energy storage system where fuel enters or exits the battery. An open system may also optionally store products and reactants. This includes, but is not limited to, a single-direction water electrolyzers that produce H₂ as a product.

### Energy Storage Systems (ESS)

Set forth herein is an energy storage system (ESS) that includes at least two modules. One module is a long duration energy storage system, referred to herein as the long duration subsystem (LDS). One module is a power system that provides power capacity in place of, or in addition to the LDS, so that the total power output or input of the ESS may be ramped up or down in a gradual and/or smooth manner. This second module is referred to herein as the buffer subsystem (BSS). An LDS typically charges and discharges at certain levels that have a large gap between each level. The BSS charges and discharges to fill in these large gaps so the total power output is finely modulated. The ESS is configured for cross-charging between the LDS and the BSS. This means that energy can conduct directly between the LDS and the BSS. The BSS may, for example, be charged by the LDS; or vice versa. The LDS and BSS may be simultaneously discharged and have current conducting from one module through the other module before circulating in an external circuit. Similarly, the LDS and BSS may be simultaneously charged from an external circuit and have current conduct from one module through the other module. In some embodiments, only one of the LDS or BSS is charged. In some other embodiments, only one of the LDS or BSS is discharged. The ESS also includes at least one processor for controlling series flow, parallel flow, charge C-rates, discharge C-rates, power electronics, or a combination thereof. The processor can alter the conduction circuit in the ESS to switch from series flow to parallel flow. In certain embodiments, the at least one processor controls series flow as just described. In certain other embodiments, the at least one processor controls parallel flow, in which current flows to, or from, the LDS and the BSS individually. In parallel flow, current conducts into or out of the LDS and the BSS but not from the LDS to the BSS or from the BSS to the LDS. In certain embodiments, the at least one processor controls charge C-rates. In certain embodiments, the at least one processor controls discharge C-rates. In certain embodiments, the at least one processor controls power electronics that include, but are not limited to, valves, switches, resistors, insulators, voltage modulators, emitter resistors, capacitors, fuel pipes, heating sources, or combinations thereof.

Certain specific combinations of LDS and BSS include, but are not limited to, the following: (a) an LDS that includes a reversible solid-oxide electrochemical cell (rSOC) that generates electricity by converting H₂ into water and a BSS that includes a Li-ion battery; (b) an LDS that includes a reversible solid-oxide electrochemical cell (rSOC) that generates electricity by converting CO into CO₂ and a BSS that includes a Li-ion battery; (c) an LDS that includes a reversible solid-oxide electrochemical cell (rSOC) that generates electricity by converting H₂ and CO into water and CO₂, and a BSS that includes a Li-ion battery; (d) an LDS that includes a reversible solid-oxide electrochemical cell (rSOC) that generates electricity by converting H₂ into water and a BSS that includes a Na-ion battery; (e) an LDS that includes a reversible solid-oxide electrochemical cell (rSOC) that generates electricity by converting CO into CO₂ and a BSS that includes a Na-ion battery; and (f) an LDS that includes a reversible solid-oxide electrochemical cell (rSOC) that generates electricity by converting H₂ and CO into water and CO₂, and a BSS that includes a Na-ion battery.

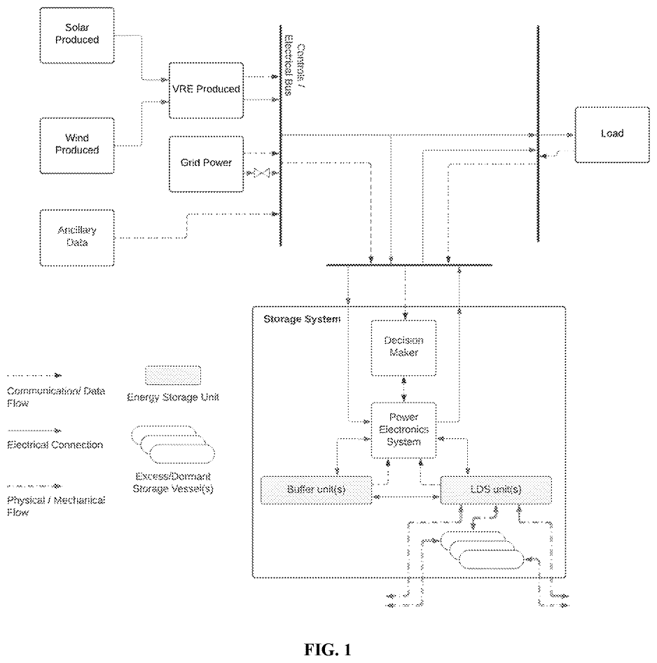

One embodiment of an ESS is shown in FIG. 1. In FIG. 1, the decision maker contains a control algorithm that dictates which electrical pathways are on or off. Parallel energy flow is enabled with energy flowing directly from the storage units from/to the supply/demand loads, while series energy flow (i.e., cross-charging) occurs through the direct connection between the buffer units (herein buffer subsystem or “BS”) and the LDS units (herein long duration subsystem or “LDS”) (potentially through the power electronics system). Ancillary data, including forecasting, price signals, and other sources, are also shown and contemplated herein.

In FIG. 1, electricity may be supplied to the Storage System, i.e., the ESS, via a variety of means. For example, solar-produced electrical energy (“Solar Produced) or wind-produced electrical energy (“Wind produced”) may supply electricity (“VRE”). VRE refers to variable renewable energy, such as, but not limited to, wind energy and solar energy. Electrical energy may also be supplied by an external electrical grid (“Grid Power”). The externally supplied electricity can be sent directly to the Load. Alternatively, the externally supplied electricity can be sent to the Power Electronics System and then to the Buffer Units, i.e., the BSS, or to the LDS units, i.e., the LDS, or both. The Buffer Units and LDS units are configured to cross-charge and can conduct current between them. For example, the LDS can charge the Buffer Units and vice versa. The Buffer Units and the LDS units can also send electrical energy to the Load. The LDS units can also direct electrical energy to excess/dormant storage vessels by coproducing chemicals or fuels that can be stored in the excess/dormant storage vessels. Physical/mechanical flow of chemicals or fuels may proceed between the excess/dormant storage vessels and the LDS units. For example, externally supplied fuel in the excess/dormant storage vessels can flow into the LDS so the LDS can use that fuel to generate electricity. Some embodiments of using externally supplied fuel is shown in FIGS. 10-13 and described in the associated description.

In FIG. 1, communication and data can be input by an Ancillary Data link or from the Load. This information can be compiled and analyzed in the Decision Maker. The Decision Maker can also acquire communication and data from the Buffer Units, the LDS units or from the Power Electronics. For example, the Decision Maker may acquire data from the LDS that fuel stored in the closed system has been used and more fuel is needed. The Decision Maker may then actuate valves to allow additional fuel to flow into the LDS units from the excess/dormant storage vessels. In another example of using this system, the Decision Maker may acquire data from the Load that informs the Decision Maker that more electrical power is needed to meet a given Load demand. The Decision Maker may then turn on a certain number of Buffer Units to increase the power output by the ESS. Ancillary Data may include data concerning incident solar radiation on solar panels, wind speed and duration at windmills, weather, time, days, energy price forecasts, or demand forecasts. The Decision Maker can then use this information to determine the appropriate number of Buffer Units and LDS Units to activate or deactivate so that the appropriate amount of energy is supplied to the load. In other examples, the Decision Maker may sense that the temperature of a given LDS or BSS is getting too high and therefore actuate devices to shut off an LDS or BSS that has too high of a temperature.

In some embodiments, including any of the foregoing, the ESS is a closed system. This means that all the fuels and reactants are stored within the ESS and are not available to leak or evaporate away from the ESS. In a closed system, only electricity goes into or out of the ESS, except for oxygen which may enter during discharge mode and may exit during charge mode. The closed system may include valves that allow the closed system to convert from a closed system to an open system.

In some embodiments, including any of the foregoing, the ESS has a charge-to-discharge power ratio (c/d) of 1 to 10. In certain embodiments, c/d is 1, 1.5, 2, 2.5, 3, 3.5, 4, 4.5, 5, 5.5, 6, 6.5, 7, 7.5, 8, 8.5, 9, 9.5, or 10. In certain embodiments c/d is a range such as 1 to 10, 2 to 10, 3 to 10, 4 to 10, 5 to 10, 6 to 10, 7 to 10, 8 to 10, or 9 to 10. In certain other embodiments c/d is a range such as 1 to 9, 1 to 8, 1 to 7, 1 to 6, 1 to 5, 1 to 4, 1 to 3, or 1 to 2. In yet other embodiments c/d is a range such as 1 to 10, 2 to 8, 3 to 7, or 4 to 6. In some specific embodiments, c/d is 1. In some specific embodiments, c/d is 1.5. In some specific embodiments, c/d is 2. In some specific embodiments, c/d is 2.5. In some specific embodiments, c/d is 3. In some specific embodiments, c/d is 3.5. In some specific embodiments, c/d is 4. In some specific embodiments, c/d is 4.5. In some specific embodiments, c/d is 5. In some specific embodiments, c/d is 5.5. In some specific embodiments, c/d is 6. In some specific embodiments, c/d is 6.5. In some specific embodiments, c/d is 7. In some specific embodiments, c/d is 7.5. In some specific embodiments, c/d is 8. In some specific embodiments, c/d is 8.5. In some specific embodiments, c/d is 9. In some specific embodiments, c/d is 9.5. In some specific embodiments, c/d is 10. In certain embodiments c/d is a range from 1 to 10. In certain embodiments c/d is a range from 2 to 10. In certain embodiments c/d is a range from 3 to 10. In certain embodiments c/d is a range from 4 to 10. In certain embodiments c/d is a range from 5 to 10. In certain embodiments c/d is a range from 6 to 10. In certain embodiments c/d is a range from 7 to 10. In certain embodiments c/d is a range from 8 to 10. In certain embodiments c/d is a range from 9 to 10. In certain other embodiments c/d is a range from 1 to 9. In certain embodiments c/d is a range from 1 to 8. In certain embodiments c/d is a range from 1 to 7. In certain embodiments c/d is a range from 1 to 6. In certain embodiments c/d is a range from 1 to 5. In certain embodiments c/d is a range from 1 to 4. In certain embodiments c/d is a range from 1 to 3. In certain embodiments c/d is a range from 1 to 2. In yet other embodiments c/d is a range from 1 to 10. In certain embodiments c/d is a range from 2 to 8. In certain embodiments c/d is a range from 3 to 7. In certain embodiments c/d is a range from 4 to 6.

In some embodiments, including any of the foregoing, the ESS has an average charge-to-discharge power ratio (c/d_{avg}) of 1 to 10. In certain embodiments, the ESS has a c/d_{avg} that is 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, or 10.

In certain embodiments, the ESS has a c/d_{avg} that is 0.1.

In certain embodiments, the ESS has a c/d_{avg} that is 0.2.

In certain embodiments, the ESS has a c/d_{avg} that is 0.3.

In certain embodiments, the ESS has a c/d_{avg} that is 0.4.

In certain embodiments, the ESS has a c/d_{avg} that is 0.5.

In certain embodiments, the ESS has a c/d_{avg} that is 0.6.

In certain embodiments, the ESS has a c/d_{avg} that is 0.7.

In certain embodiments, the ESS has a c/d_{avg} that is 0.8.

In certain embodiments, the ESS has a c/d_{avg} that is 0.9.

In some embodiments, including any of the foregoing, the ESS has an average charge-to-discharge power ratio (c/d_{avg}) of 1 to 10. In certain embodiments, the ESS has a c/d_{avg} that is 1, 1.5, 2, 2.5, 3, 3.5, 4, 4.5, 5, 5.5, 6, 6.5, 7, 7.5, 8, 8.5, 9, 9.5, or 10. In certain embodiments, the ESS has a c/d_{avg} that is a range such as 1 to 10, 2 to 10, 3 to 10, 4 to 10, 5 to 10, 6 to 10, 7 to 10, 8 to 10, or 9 to 10. In certain other embodiments, the ESS has a c/d_{avg} that is a range such as 1 to 9, 1 to 8, 1 to 7, 1 to 6, 1 to 5, 1 to 4, 1 to 3, or 1 to 2. In yet other embodiments c/d_{avg} is a range such as 1 to 10, 2 to 8, 3 to 7, or 4 to 6. In some specific embodiments, c/d_{avg} is 1. In some specific embodiments, c/d_{avg} is 1.5. In some specific embodiments, c/d_{avg} is 2. In some specific embodiments, c/d_{avg} is 2.5. In some specific embodiments, c/d_{avg} is 3. In some specific embodiments, c/d_{avg} is 3.5. In some specific embodiments, c/d_{avg} is 4. In some specific embodiments, c/d_{avg} is 4.5. In some specific embodiments, c/d_{avg} is 5. In some specific embodiments, c/d_{avg} is 5.5. In some specific embodiments, c/d_{avg} is 6. In some specific embodiments, c/d_{avg} is 6.5. In some specific embodiments, c/d_{avg} is 7. In some specific embodiments, c/d_{avg} is 7.5. In some specific embodiments, c/d_{avg} is 8. In some specific embodiments, c/d_{avg} is 8.5. In some specific embodiments, c/d_{avg} is 9. In some specific embodiments, c/d_{avg} is 9.5. In some specific embodiments, c/d_{avg} is 10. In certain embodiments, the ESS has a c/d_{avg} that is a range from 1 to 10. In certain embodiments, the ESS has a c/d_{avg} that is a range from 2 to 10. In certain embodiments, the ESS has a c/d_{avg} that is a range from 3 to 10. In certain embodiments, the ESS has a c/d_{avg} that is a range from 4 to 10. In certain embodiments, the ESS has a c/d_{avg} that is a range from 5 to 10. In certain embodiments, the ESS has a c/d_{avg} that is a range from 6 to 10. In certain embodiments, the ESS has a c/d_{avg} that is a range from 7 to 10. In certain embodiments, the ESS has a c/d_{avg} that is a range from 8 to 10. In certain embodiments, the ESS has a c/d_{avg} that is a range from 9 to 10. In certain other embodiments, the ESS has a c/d_{avg} that is a range from 1 to 9. In certain other embodiments, the ESS has a c/d_{avg} that is a range from 1 to 8. In certain other embodiments, the ESS has a c/d_{avg} that is a range from 1 to 7. In certain other embodiments, the ESS has a c/d_{avg} that is a range from 1 to 6. In certain other embodiments, the ESS has a c/d_{avg} that is a range from 1 to 5. In certain other embodiments, the ESS has a c/d_{avg} that is a range from 1 to 4. In certain other embodiments, the ESS has a c/d_{avg} that is a range from 1 to 3. In certain other embodiments, the ESS has a c/d_{avg} that is a range from 1 to 2. In yet other embodiments c/d_{avg} is a range from 1 to 10. In yet other embodiments c/d_{avg} is a range from 2 to 8. In yet other embodiments c/d_{avg} is a range from 3 to 7. In yet other embodiments c/d_{avg} is a range from 4 to 6.

In some embodiments, including any of the foregoing, the ESS has a peak charge-to-discharge power ratio (c/dₚₖ) of 1 to 10. In certain embodiments, the ESS has a c/dₚₖ that is 1, 1.5, 2, 2.5, 3, 3.5, 4, 4.5, 5, 5.5, 6, 6.5, 7, 7.5, 8, 8.5, 9, 9.5, or 10. In certain embodiments, the ESS has a c/dₚₖ that is a range such as 1 to 10, 2 to 10, 3 to 10, 4 to 10, 5 to 10, 6 to 10, 7 to 10, 8 to 10, or 9 to 10. In certain other embodiments, the ESS has a c/dₚₖ that is a range such as 1 to 9, 1 to 8, 1 to 7, 1 to 6, 1 to 5, 1 to 4, 1 to 3, or 1 to 2. In yet other embodiments c/dₚₖ is a range such as 1 to 10, 2 to 8, 3 to 7, or 4 to 6. In some specific embodiments, c/dₚₖ is 1. In some specific embodiments, c/dₚₖ is 1.5. In some specific embodiments, c/dₚₖ is 2. In some specific embodiments, c/dₚₖ is 2.5. In some specific embodiments, c/dₚₖ is 3. In some specific embodiments, c/dₚₖ is 3.5. In some specific embodiments, c/dₚₖ is 4. In some specific embodiments, c/dₚₖ is 4.5. In some specific embodiments, c/dₚₖ is 5. In some specific embodiments, c/dₚₖ is 5.5. In some specific embodiments, c/dₚₖ is 6. In some specific embodiments, c/dₚₖ is 6.5. In some specific embodiments, c/dₚₖ is 7. In some specific embodiments, c/dₚₖ is 7.5. In some specific embodiments, c/dₚₖ is 8. In some specific embodiments, c/dₚₖ is 8.5. In some specific embodiments, c/dₚₖ is 9. In some specific embodiments, c/dₚₖ is 9.5. In some specific embodiments, c/dₚₖ is 10. In certain embodiments, the ESS has a c/dₚₖ that is a range from 1 to 10. In certain embodiments, the ESS has a c/dₚₖ that is a range from 2 to 10. In certain embodiments, the ESS has a c/dₚₖ that is a range from 3 to 10. In certain embodiments, the ESS has a c/dₚₖ that is a range from 4 to 10. In certain embodiments, the ESS has a c/dₚₖ that is a range from 5 to 10. In certain embodiments, the ESS has a c/dₚₖ that is a range from 6 to 10. In certain embodiments, the ESS has a c/dₚₖ that is a range from 7 to 10. In certain embodiments, the ESS has a c/dₚₖ that is a range from 8 to 10. In certain embodiments, the ESS has a c/dₚₖ that is a range from 9 to 10. In certain other embodiments, the ESS has a c/dₚₖ that is a range from 1 to 9. In certain other embodiments, the ESS has a c/dₚₖ that is a range from 1 to 8. In certain other embodiments, the ESS has a c/dₚₖ that is a range from 1 to 7. In certain other embodiments, the ESS has a c/dₚₖ that is a range from 1 to 6. In certain other embodiments, the ESS has a c/dₚₖ that is a range from 1 to 5. In certain other embodiments, the ESS has a c/dₚₖ that is a range from 1 to 4. In certain other embodiments, the ESS has a c/dₚₖ that is a range from 1 to 3. In certain other embodiments, the ESS has a c/dₚₖ that is a range from 1 to 2.

In some embodiments, including any of the foregoing, the LDS, BSS, or both, have a c/d_{avg} ratio of 1 to 10. In certain embodiments, the LDS, BSS, or both, have a c/d_{avg} that is 1, 1.5, 2, 2.5, 3, 3.5, 4, 4.5, 5, 5.5, 6, 6.5, 7, 7.5, 8, 8.5, 9, 9.5, or 10. In certain embodiments, the LDS, BSS, or both, have a c/d_{avg} that is a range such as 1 to 10, 2 to 10, 3 to 10, 4 to 10, 5 to 10, 6 to 10, 7 to 10, 8 to 10, or 9 to 10. In certain other embodiments the LDS, BSS, or both, have a c/d_{avg} that is a range such as 1 to 9, 1 to 8, 1 to 7, 1 to 6, 1 to 5, 1 to 4, 1 to 3, or 1 to 2. In yet other embodiments, the LDS, BSS, or both, have a c/d_{avg} that is a range such as 1 to 10, 2 to 8, 3 to 7, or 4 to 6. In some specific embodiments, the LDS, BSS, or both, have a c/d_{avg} that is 1. In some specific embodiments, the LDS, BSS, or both, have a c/d_{avg} that is 1.5. In some specific embodiments, the LDS, BSS, or both, have a c/d_{avg} that is 2. In some specific embodiments, the LDS, BSS, or both, have a c/d_{avg} that is 2.5. In some specific embodiments, the LDS, BSS, or both, have a c/d_{avg} that is 3. In some specific embodiments, the LDS, BSS, or both, have a c/d_{avg} that is 3.5. In some specific embodiments, the LDS, BSS, or both, have a c/d_{avg} that is 4. In some specific embodiments, the LDS, BSS, or both, have a c/d_{avg} that is 4.5. In some specific embodiments, the LDS, BSS, or both, have a c/d_{avg} that is 5. In some specific embodiments, the LDS, BSS, or both, have a c/d_{avg} that is 5.5. In some specific embodiments, the LDS, BSS, or both, have a c/d_{avg} that is 6. In some specific embodiments, the LDS, BSS, or both, have a c/d_{avg} that is 6.5. In some specific embodiments, the LDS, BSS, or both, have a c/d_{avg} that is 7. In some specific embodiments, the LDS, BSS, or both, have a c/d_{avg} that is 7.5. In some specific embodiments, the LDS, BSS, or both, have a c/d_{avg} that is 8. In some specific embodiments, the LDS, BSS, or both, have a c/d_{avg} that is 8.5. In some specific embodiments, the LDS, BSS, or both, have a c/d_{avg} that is 9. In some specific embodiments, the LDS, BSS, or both, have a c/d_{avg} that is 9.5. In some specific embodiments, the LDS, BSS, or both, have a c/d_{avg} that is 10. In certain embodiments, the LDS, BSS, or both, have a c/d_{avg} that is a range from 1 to 10. In certain embodiments, the LDS, BSS, or both, have a c/d_{avg} that is a range from 2 to 10. In certain embodiments, the LDS, BSS, or both, have a c/d_{avg} that is a range from 3 to 10. In certain embodiments, the LDS, BSS, or both, have a c/d_{avg} that is a range from 4 to 10. In certain embodiments, the LDS, BSS, or both, have a c/d_{avg} that is a range from 5 to 10. In certain embodiments, the LDS, BSS, or both, have a c/d_{avg} that is a range from 6 to 10. In certain embodiments, the LDS, BSS, or both, have a c/d_{avg} that is a range from 7 to 10. In certain embodiments, the LDS, BSS, or both, have a c/d_{avg} that is a range from 8 to 10. In certain embodiments, the LDS, BSS, or both, have a c/d_{avg} that is a range from 9 to 10. In certain other embodiments the LDS, BSS, or both, have a c/d_{avg} that is a range from 1 to 9. In certain other embodiments the LDS, BSS, or both, have a c/d_{avg} that is a range from 1 to 8. In certain other embodiments the LDS, BSS, or both, have a c/d_{avg} that is a range from 1 to 7. In certain other embodiments the LDS, BSS, or both, have a c/d_{avg} that is a range from 1 to 6. In certain other embodiments the LDS, BSS, or both, have a c/d_{avg} that is a range from 1 to 5. In certain other embodiments the LDS, BSS, or both, have a c/d_{avg} that is a range from 1 to 4. In certain other embodiments the LDS, BSS, or both, have a c/d_{avg} that is a range from 1 to 3. In certain other embodiments the LDS, BSS, or both, have a c/d_{avg} that is a range from 1 to 2. In yet other embodiments, the LDS, BSS, or both, have a c/d_{avg} that is a range from 1 to 10. In yet other embodiments, the LDS, BSS, or both, have a c/d_{avg} that is a range from 2 to 8 In yet other embodiments, the LDS, BSS, or both, have a c/d_{avg} that is a range from 3 to 7. In yet other embodiments, the LDS, BSS, or both, have a c/d_{avg} that is a range from 4 to 6.

In some embodiments, including any of the foregoing, the LDS, BSS, or both, have a c/dₚₖ ratio of 1 to 10. In certain embodiments, the LDS, BSS, or both, have a c/dₚₖ that is 1, 1.5, 2, 2.5, 3, 3.5, 4, 4.5, 5, 5.5, 6, 6.5, 7, 7.5, 8, 8.5, 9, 9.5, or 10. In certain embodiments, the LDS, BSS, or both, have a c/dₚₖ that is a range such as 1 to 10, 2 to 10, 3 to 10, 4 to 10, 5 to 10, 6 to 10, 7 to 10, 8 to 10, or 9 to 10. In certain other embodiments the LDS, BSS, or both, have a c/dₚₖ that is a range such as 1 to 9, 1 to 8, 1 to 7, 1 to 6, 1 to 5, 1 to 4, 1 to 3, or 1 to 2. In yet other embodiments, the LDS, BSS, or both, have a c/dₚₖ that is a range such as 1 to 10, 2 to 8, 3 to 7, or 4 to 6. In some specific embodiments, the LDS, BSS, or both, have a c/dₚₖ that is 1. In some specific embodiments, the LDS, BSS, or both, have a c/dₚₖ that is 1.5. In some specific embodiments, the LDS, BSS, or both, have a c/dₚₖ that is 2. In some specific embodiments, the LDS, BSS, or both, have a c/dₚₖ that is 2.5. In some specific embodiments, the LDS, BSS, or both, have a c/dₚₖ that is 3. In some specific embodiments, the LDS, BSS, or both, have a c/dₚₖ that is 3.5. In some specific embodiments, the LDS, BSS, or both, have a c/dₚₖ that is 4. In some specific embodiments, the LDS, BSS, or both, have a c/dₚₖ that is 4.5. In some specific embodiments, the LDS, BSS, or both, have a c/dₚₖ that is 5. In some specific embodiments, the LDS, BSS, or both, have a c/dₚₖ that is 5.5. In some specific embodiments, the LDS, BSS, or both, have a c/dₚₖ that is 6. In some specific embodiments, the LDS, BSS, or both, have a c/dₚₖ that is 6.5. In some specific embodiments, the LDS, BSS, or both, have a c/dₚₖ that is 7. In some specific embodiments, the LDS, BSS, or both, have a c/dₚₖ that is 7.5. In some specific embodiments, the LDS, BSS, or both, have a c/dₚₖ that is 8. In some specific embodiments, the LDS, BSS, or both, have a c/dₚₖ that is 8.5. In some specific embodiments, the LDS, BSS, or both, have a c/dₚₖ that is 9. In some specific embodiments, the LDS, BSS, or both, have a c/dₚₖ that is 9.5. In some specific embodiments, the LDS, BSS, or both, have a c/dₚₖ that is 10. In certain embodiments, the LDS, BSS, or both, have a c/dₚₖ that is a range from 1 to 10. In certain embodiments, the LDS, BSS, or both, have a c/dₚₖ that is a range from 2 to 10. In certain embodiments, the LDS, BSS, or both, have a c/dₚₖ that is a range from 3 to 10. In certain embodiments, the LDS, BSS, or both, have a c/dₚₖ that is a range from 4 to 10. In certain embodiments, the LDS, BSS, or both, have a c/dₚₖ that is a range from 5 to 10. In certain embodiments, the LDS, BSS, or both, have a c/dₚₖ that is a range from 6 to 10. In certain embodiments, the LDS, BSS, or both, have a c/dₚₖ that is a range from 7 to 10. In certain embodiments, the LDS, BSS, or both, have a c/dₚₖ that is a range from 8 to 10. In certain embodiments, the LDS, BSS, or both, have a c/dₚₖ that is a range from 9 to 10. In certain other embodiments the LDS, BSS, or both, have a c/dₚₖ that is a range from 1 to 9. In certain embodiments, the LDS, BSS, or both, have a c/dₚₖ that is a range from 1 to 8. In certain embodiments, the LDS, BSS, or both, have a c/dₚₖ that is a range from 1 to 7. In certain embodiments, the LDS, BSS, or both, have a c/dₚₖ that is a range from 1 to 6. In certain embodiments, the LDS, BSS, or both, have a c/dₚₖ that is a range from 1 to 5. In certain embodiments, the LDS, BSS, or both, have a c/dₚₖ that is a range from 1 to 4. In certain embodiments, the LDS, BSS, or both, have a c/dₚₖ that is a range from 1 to 3. In certain embodiments, the LDS, BSS, or both, have a c/dₚₖ that is a range from 1 to 2. In yet other embodiments, the LDS, BSS, or both, have a c/dₚₖ that is a range from 1 to 10. In yet other embodiments, the LDS, BSS, or both, have a c/dₚₖ that is a range from 2 to 8. In yet other embodiments, the LDS, BSS, or both, have a c/dₚₖ that is a range from 3 to 7. In yet other embodiments, the LDS, BSS, or both, have a c/dₚₖ that is a range from 4 to 6.

In some embodiments, including any of the foregoing, the LDS, BSS, or both, have a c/dₚₖ ratio of 1 to 10. In some embodiments, including any of the foregoing, the LDS, BSS, or both, have an c/d_{avg} ratio of 3 to 5. In some embodiments, including any of the foregoing, the LDS, BSS, or both, have a c/dₚₖ ratio of 7 to 10.

In some embodiments, including any of the foregoing, the ESS has a c/d_{avg} that is about 2.4, about 4.2, or about 5.7. In some embodiments, including any of the foregoing, the ESS has a c/dₚₖ that is about 3.5, about 5.7, or about 8.9. In certain embodiments, including any of the foregoing, the ESS has a c/d_{avg} that is about 2.4. In certain embodiments, including any of the foregoing, the ESS has a c/d_{avg} that is about 4.2. In certain embodiments, including any of the foregoing, the ESS has a c/d_{avg} that is about 5.7. In certain embodiments, including any of the foregoing, the ESS has a c/dₚₖ that is about 3.5. In certain embodiments, including any of the foregoing, the ESS has a c/dₚₖ that is about 5.7. In certain embodiments, including any of the foregoing, the ESS has a c/dₚₖ that is about 8.9.

In some embodiments, including any of the foregoing, the LDS:BSS energy capacity ratio is 1:1 to 100:1. For example, the LDS:BSS energy capacity ratio may be 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, or 100:1

In some embodiments, including any of the foregoing, the ESS has an LDS:BSS energy capacity ratio that is 8:1 or higher. For example, the ESS may have an LDS:BSS energy capacity ratio of 10:1 or higher, 20:1 or higher, 30:1 or higher, 40:1 or higher, 50:1 or higher, 60:1 or higher, 70:1 or higher, 80:1 or higher, 90:1 or higher, 100:1 or higher. For example, the ESS may have an LDS:BSS energy capacity ratio of 100:1 or higher, 200:1 or higher, 300:1 or higher, 400:1 or higher, 500:1 or higher, 600:1 or higher, 700:1 or higher, 800:1 or higher, or 900:1 or higher.

In some embodiments, including any of the foregoing, the LDS:BSS energy capacity ratio is 10:1.

In some embodiments, including any of the foregoing, the LDS:BSS energy capacity ratio is 12.5:1.

In some embodiments, including any of the foregoing, the LDS:BSS energy capacity ratio is 15:1.

In some embodiments, including any of the foregoing, the LDS:BSS energy capacity ratio is 17.5:1.

In some embodiments, including any of the foregoing, the LDS:BSS energy capacity ratio is 20:1.

In some embodiments, including any of the foregoing, the LDS:BSS energy capacity ratio is 22.5:1.

In some embodiments, including any of the foregoing, the LDS:BSS energy capacity ratio is 25:1.

In some embodiments, including any of the foregoing, the LDS:BSS energy capacity ratio is 27.5:1.

In some embodiments, including any of the foregoing, the LDS:BSS energy capacity ratio is 30:1.

In some embodiments, including any of the foregoing, the LDS:BSS energy capacity ratio is 32.5:1.

In some embodiments, including any of the foregoing, the LDS:BSS energy capacity ratio is 35:1.

In some embodiments, including any of the foregoing, the LDS:BSS energy capacity ratio is 37.5:1.

In some embodiments, including any of the foregoing, the LDS:BSS energy capacity ratio is 40:1.

In some embodiments, including any of the foregoing, the LDS:BSS energy capacity ratio is 42.5:1.

In some embodiments, including any of the foregoing, the LDS:BSS energy capacity ratio is 45:1.

In some embodiments, including any of the foregoing, the LDS:BSS energy capacity ratio is 10:1 or higher.

In some embodiments, including any of the foregoing, the LDS:BSS energy capacity ratio is less than 1000:1.

In some embodiments, including any of the foregoing, the LDS operates at a lower C-rate than the BSS. This means that, in certain embodiments, the time it takes the LDS to fully discharge in maximum capacity is less than the time it takes for the BSS to fully discharge its maximum capacity; or the time it takes the LDS to fully charge to is maximum capacity is less than the time it takes for the BSS to fully charge to its maximum capacity.

In some embodiments, including any of the foregoing, the LDS includes a rSOC flow battery, nickel-hydrogen battery, an iron flow battery, a vanadium flow battery, or a combination thereof. In certain embodiments, the LDS includes a rSOC flow battery. In certain embodiments, the LDS includes a nickel-hydrogen battery. In certain embodiments, the LDS includes an iron flow battery. In certain embodiments, the LDS includes a vanadium flow battery. In some embodiments, including any of the foregoing, the LDS includes a combination of a rSOC flow battery, nickel-hydrogen battery, an iron flow battery, and a vanadium flow battery.

In some embodiments, including any of the foregoing, the LDS includes metal-air batteries. In some embodiments, including any of the foregoing, the LDS includes iron-air batteries. In some embodiments, including any of the foregoing, the LDS includes zinc-air batteries.

In some other embodiments, including any of the foregoing, the ESS includes at least one fly wheel.

In some other embodiments, including any of the foregoing, the LDS includes at least one fly wheel.

In some other embodiments, including any of the foregoing, the ESS includes at least on supercapacitor.

In some other embodiments, including any of the foregoing, the LDS includes at least one supercapacitor.

In some embodiments, including any of the foregoing, the rSOC is a solid-oxide electrochemical cell. In some other embodiments, the rSOC is a stack of solid-oxide electrochemical cells. In certain embodiments, the stack includes ten rSOCs. In certain embodiments, the stack includes twenty rSOCs. In certain embodiments, the stack includes thirty rSOCs. In certain embodiments, the stack includes forty rSOCs. In certain embodiments, the stack includes fifty rSOCs. In certain embodiments, the stack includes sixty rSOCs. In certain embodiments, the stack includes seventy rSOCs. In certain embodiments, the stack includes eighty rSOCs. In certain embodiments, the stack includes ninety rSOCs. In certain embodiments, the stack includes one-hundred rSOCs. In certain embodiments, the stack includes two-hundred rSOCs. In certain embodiments, the stack includes three-hundred rSOCs. In certain embodiments, the stack includes four-hundred rSOCs. In certain embodiments, the stack includes five-hundred rSOCs. In certain embodiments, the stack includes six-hundred rSOCs. In certain embodiments, the stack includes seven-hundred rSOCs. In certain embodiments, the stack includes eight-hundred rSOCs. In certain embodiments, the stack includes nine-hundred rSOCs. In certain embodiments, the stack includes one-thousand rSOCs. In certain embodiments, the stack includes one-hundred to one-thousand rSOCs.

In some embodiments, the rSOC is an electrochemical cell that has a Ni-based catalyst. In some other embodiments, the rSOC is an electrochemical cell that has a Ni catalyst. In other embodiments, the rSOC is an electrochemical cell that has a nickel rhodium (Ni—Rh) catalyst. In some other embodiments, the rSOC is an electrochemical cell that has a nickel molybdenum (Ni—Mo) catalyst. In some embodiments, the rSOC is an electrochemical cell that has a ceramic catalyst. The ceramic catalyst may be selected from yttria-stabilized zirconia (YSZ), ceria (CeO₃), gadolinium-doped ceria (GDC), a ceria/bismuth oxide, Ba(Zr_{0.1}Ce_{0.7}Y_{0.2}) O_{3-δ} (BZCY7), lanthanum strontium manganite (LSM), or lanthanum strontium cobalt ferrite (LSCF). In certain embodiments, the ceramic catalyst is yttria-stabilized zirconia (YSZ). In certain embodiments, the ceramic catalyst is ceria (CeO₃). In certain embodiments, the ceramic catalyst is gadolinium-doped ceria (GDC). In certain embodiments, the ceramic catalyst is a ceria/bismuth oxide. In certain embodiments, the ceramic catalyst is Ba(Zr_{0.1}Ce_{0.7}Y_{0.2})O_{3-δ} (BZCY7). In certain embodiments, the ceramic catalyst is lanthanum strontium manganite (LSM). In certain embodiments, the ceramic catalyst is lanthanum strontium cobalt ferrite (LSCF). In certain other embodiments, the rSOC is a solid oxide fuel cell that optimally operates at temperatures between 500° C. and 1000° C.

In some embodiments, including any of the foregoing, the LDS is coupled to a storage tank and configured to operate as at least one flow battery. In this configuration, the storage tank stores a fuel for the rSOC that is useful for generating electricity; or the storage tank includes an electrolyte that is useful for generating electricity in a flow battery such as a vanadium flow battery or an iron flow battery. The fuel for the rSOC can include any fuel known in the art that is compatible with solid oxide cells; or any electrolyte fuel known in the art that is compatible with flow batteries. For example, the fuel may include, but is not limited to, hydrogen, natural gas, ethanol, methanol, propane, ammonia, hydrazine, or other fuels for solid oxide fuel cells. In other embodiments, the storage tank may include H₂ as a fuel that is converted to H₂O using O₂, in the air or atmosphere or in a storage tank. As H₂ and O₂ convert into H₂O, another storage tank may be filled with the H₂O that is formed. In some scenarios, the formed H₂O may be removed and replaced with H₂ to again act as a fuel source for a rSOC.

In some embodiments, including any of the foregoing, the LDS is coupled to a delivered fuel source, a fuel truck, or a combination thereof, and configured to operate as at least one flow battery. For example, the LDS may have mechanical couplings attached that connect to a fuel truck to use fuel that is delivered. In other embodiments, the LDS may have mechanical couplings attached that connect to an external pipe or pipeline that transmits a fuel source. When operated in the reverse mode (i.e., electrolyzer mode) the LDS rSOC may be used to coproduce fuel that is delivered to a fuel truck, pipeline, external storage tank, or combination thereof. Some embodiments of using external sources (e.g. truck, pipeline, railroad, shipping) or generate fuel that is shipped off by the systems and processes disclosed herein are shown in FIGS. 10-13 and described in the associated description.

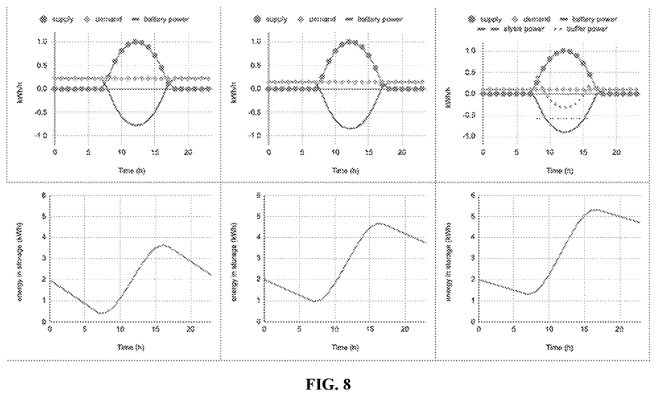

For example, FIG. 8 shows one example of coproduction of fuels. As seen in the bottom-right plot, by combining an rSOC LDS with a BSS, the resulting ESS system as a whole operates at a far greater c/d_{avg} and c/dₚₖ than a conventional rSOC system, or other known LDS systems. Also, by combining an rSOC LDS with a BSS, the resulting ESS system has an improved round-trip efficiency compared to a system with just an LDS. This is one example where a higher c/d ratio allows better load matching with supply and demand. The higher c/d ratio is a result of pairing an LDS with a BSS. This is beneficial for coproduction of fuels but for other applications too. See EXAMPLE 1, below, for additional details. See also FIGS. 10-13 and the associated description.

In some embodiments, including any of the foregoing, the LDS is configured to operate for 20-50 hours. Operate in this paragraph includes, but is not limited to, discharging for 20-50 hours. Operate in this paragraph includes having an energy capacity over discharge power capacity of 20-50 hours. The LDS described herein is modular and can be sized according to a variety of market demands. Depending on the size of the LDS, or the number of LDS, and the amount of fuel available, either stored internally or stored or delivered externally, the LDS can operate for a variety of time periods. In certain embodiments, the LDS is configured to operate for 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 hours.

In some embodiments, including any of the foregoing, the at least one rSOC flow battery includes a carbon-chemistry system, a hydrogen-chemistry system, a carbon-hydrogen-chemistry system, an ammonia-chemistry system, an iron-chemistry system, or a combination thereof. In some embodiments, including any of the foregoing, the at least one rSOC flow battery includes a carbon-chemistry system. In some embodiments, including any of the foregoing, the at least one rSOC flow battery includes a hydrogen-chemistry system. In some embodiments, including any of the foregoing, the at least one rSOC flow battery includes a carbon-hydrogen-chemistry system. In some embodiments, including any of the foregoing, the at least one rSOC flow battery includes an ammonia-chemistry system. In some embodiments, including any of the foregoing, the at least one rSOC flow battery includes an iron-chemistry system. In some embodiments, including any of the foregoing, the at least one rSOC flow battery includes a combination of a carbon-chemistry system, a hydrogen-chemistry system, a carbon-hydrogen-chemistry system, an ammonia-chemistry system, and an iron-chemistry system. In certain embodiments, the at least one rSOC flow battery is or includes a carbon-chemistry system. In certain embodiments, the at least one rSOC flow battery is or includes an ammonia-chemistry system. In certain embodiments, the at least one rSOC flow battery is or includes an iron-chemistry system.

In some embodiments, including any of the foregoing, the entire rSOC flow battery system operates according to the following reactions: (a) H₂O↔H₂+0.5O₂; (b) CO₂↔CO+0.5O₂; or (c) a combination of (a) and (b). (a) in this paragraph is referred to as the H₂/water system. (b) in this paragraph is referred to as the CO/CO₂ system. (c) in this paragraph is referred to as a combination of the H₂/water system and CO/CO₂ system. Certain specific combinations of LDS and BSS include, but are not limited to, the following: (a1) an LDS that includes the H₂/water system, and a BSS that includes a Li-ion battery; (b1) an LDS that includes the CO/CO₂ system, and a BSS that includes a Li-ion battery; (c1) an LDS that includes a combination of the H₂/water system and CO/CO₂ system, and a BSS that includes a Li-ion battery; (d1) an LDS that includes H₂/water system and a BSS that includes a Na-ion battery; (e) an LDS that includes the CO/CO₂ system, and a BSS that includes a Na-ion battery; and (f) an LDS that includes a combination of the H₂/water system and CO/CO₂ system, and a BSS that includes a Na-ion battery.

In some embodiments, including any of the foregoing, the at least one rSOC flow battery operates to generate electricity according to the following reversible reaction that occur in the rSOC: C+O₂↔CO₂+electricity. This reaction can also work in electrolyze mode to use electricity and form charged media according to the following reversible reaction: CO₂+electricity↔C+O₂.

In some embodiments, including any of the foregoing, the at least one rSOC flow battery operates to generate electricity according to the following reversible reaction that occur in the rSOC: H₂+O₂↔H₂O+electricity. This reaction can also work in electrolyze mode to use electricity and form charged media according to the following reversible reaction: H₂O+electricity↔H₂+O₂.

In some embodiments, including any of the foregoing, the at least one rSOC flow battery operates to generate electricity according to the following reversible reaction that occur in the rSOC: CH₃OH+O₂↔CO₂+H₂O+electricity. This reaction can also work in electrolyze mode to use electricity and form charged media according to the following reversible reaction: CO₂+H₂O+electricity↔CH₃OH+O₂.

In some embodiments, including any of the foregoing, the carbon-hydrogen-chemistry system is configured to use as fuel, or generate as a product, alcohols, hydrocarbons, or a combination thereof. In some embodiments, including any of the foregoing, the carbon-hydrogen-chemistry system is configured to use as fuel, or generate as a product, alcohols. In some embodiments, including any of the foregoing, the carbon-hydrogen-chemistry system is configured to use as fuel, or generate as a product, hydrocarbons. In some embodiments, including any of the foregoing, the carbon-hydrogen-chemistry system is configured to use as fuel, or generate as a product, a combination of alcohols and hydrocarbons. The fuel or product may include, but is not limited to, methane, methanol, ethane, ethanol, propane, propanol, butane, butanol, gasoline, diesel, jet fuel, formic acid, dimethyl ether, and biogas.

In some embodiments, the fuel is methane. In some embodiments, the fuel is methanol. In some embodiments, the fuel is ethane. In some embodiments, the fuel is ethanol. In some embodiments, the fuel is propane. In some embodiments, the fuel is propanol. In some embodiments, the fuel is butane. In some embodiments, the fuel is butanol. In some embodiments, the fuel is gasoline. In some embodiments, the fuel is diesel. In some embodiments, the fuel is jet fuel. In some embodiments, the fuel is formic acid. In some embodiments, the fuel is dimethyl ether. In some embodiments, the fuel is biogas.

In some embodiments, including any of the foregoing, the hydrocarbons are selected from aromatic hydrocarbons, saturated alicyclic hydrocarbon, or a combination thereof. In some embodiments, including any of the foregoing, the hydrocarbons are aromatic hydrocarbons. In some embodiments, including any of the foregoing, the hydrocarbons are saturated alicyclic hydrocarbons. In some embodiments, including any of the foregoing, the hydrocarbons are a combination of aromatic hydrocarbons and saturated alicyclic hydrocarbons.

In some embodiments, including any of the foregoing, the LDS includes different sized power modules and energy modules. The LDS may include multiple modules of different types and sizes. The LDS may include multiple modules of different types and that have different energy capacities, power capacities, or a combination thereof.

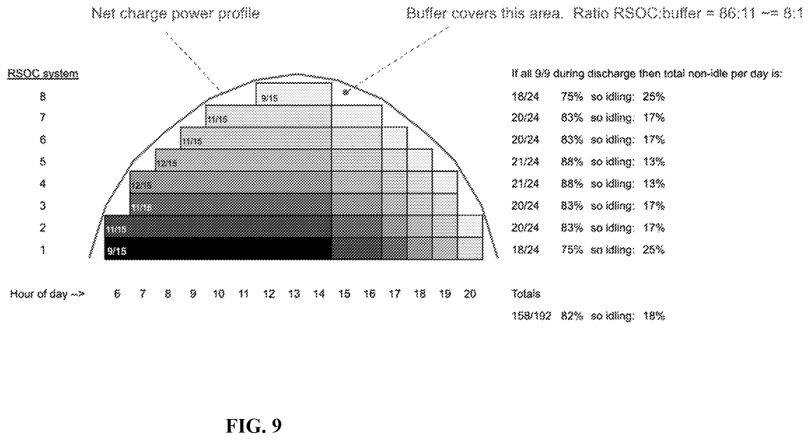

See, for example, FIG. 9, and EXAMPLE 3, which show operation of a system with multiple power modules with the LDS subsystem. The resulting ESS that has multiple power modules with the LDS subsystem provides a smooth net charge power profile by having the BSS fill in the gaps between the LDS charge profile and the net charge power profile. See EXAMPLE 3 below for details. FIG. 9 and EXAMPLE 3 show that an LDS subsystem can have several different power modules. Each of these power modules can operate independently. When multiple power modules operate together, the total LDS power is the sum of however many are operating. A control algorithm can be used that minimizes idling. The control algorithm also allows for the easy scaling of power up or down. For example, as shown in FIG. 9, two modules out of ten can operate if the demand is 20% of the total LDS power capacity. Each rSOC unit is able to scale power up and down easily. This also allows balance of system (BOS) components selections, e.g., compressors, more easily since they won't have to be operational at full scale. This also allows for building and deploying a variety of systems. This also has geometric benefits since the ESS can be designed, for example, as ten units in which each unit has 100 kW modules instead of one large 1 MW module.

In some embodiments, including any of the foregoing, the LDS includes power modules and energy modules configured to operate collectively.

In some embodiments, including any of the foregoing, the LDS includes at least one power component and at least one energy component. This means that, in certain embodiments, the LDS includes at least two subsystems. One subsystem would have a higher energy capacity than the other subsystem but a lower power capacity than the other subsystem.

In some embodiments, including any of the foregoing, the LDS includes separate power modules and energy modules that can be integrated and combined. In certain embodiments, these combinations are in shipping containers. In other embodiments, there would be one shipping container for a power module and another shipping container for an energy module. Multiple shipping containers could be coupled together to achieve a given power output.

In some embodiments, the power module is 100 kW and a 500 kW application is desired. In this scenario, five of the power modules could be combined or stacked together in one deployment. If the application demand changed to 800 kW, three more power modules could be added. In some embodiments, the power modules could be sized at 100 kW, 200 kW, 300 kW, 400 kW, 500 kW, 600 kW, 700 kW, 800 kW, 900 kW, or 1 MW. In some embodiments, the energy modules could be sized at 500 kWh, 1 MWh, 2 MWh, 3 MWh, 5 MWh, 10 MWh, 25 MWh, 50 MWh, or 100 MWh. Any combination of these power modules and energy modules could be achieved according to this disclosure. In certain embodiments, the ESS is configured to operate for 10 hours-5,000 hours using various combinations of power and energy modules. These lists are not exhaustive and other combinations of power modules and energy modules are contemplated.

In some embodiments, including any of the foregoing, the power module is 100 kW.

In some embodiments, including any of the foregoing, the power module is 150 kW.

In some embodiments, including any of the foregoing, the power module is 200 kW.

In some embodiments, including any of the foregoing, the power module is 250 kW.

In some embodiments, including any of the foregoing, the power module is 300 kW.

In some embodiments, including any of the foregoing, the power module is 350 kW.

In some embodiments, including any of the foregoing, the power module is 400 kW.

In some embodiments, including any of the foregoing, the power module is 450 kW.

In some embodiments, including any of the foregoing, the power module is 500 kW.

In some embodiments, including any of the foregoing, the power module is 550 kW.

In some embodiments, including any of the foregoing, the size of the power component and the energy component are different.

In some embodiments, including any of the foregoing, the ESS is a 150 kW system. In such an example, the total power output of the LDS and BSS would sum to 150 KW. For example, the ESS may include a 50 KW LDS module and a 100 kW BSS module. This is an example of an ESS that has a 150 KW system output. Also, for example, the ESS may include a 75 kW LDS module and a 75 kW BSS module. This is also an example of an ESS that has a 150 KW system output.

In some embodiments, including any of the foregoing, the ESS is a 1 MWh system.

In some embodiments, including any of the foregoing, the ESS is a 10 MWh system.

In some embodiments, including any of the foregoing, the ESS is a 100 MWh system.

In some embodiments, including any of the foregoing, the ESS is a 200 MWh system.

In some embodiments, including any of the foregoing, the ESS is a 300 MWh system.

In some embodiments, including any of the foregoing, the ESS is a 400 MWh system.

In some embodiments, including any of the foregoing, the ESS is a 500 MWh system.

In some embodiments, including any of the foregoing, the ESS is a 600 MWh system.

In some embodiments, including any of the foregoing, the ESS is a 700 MWh system.

In some embodiments, including any of the foregoing, the ESS is an 800 MWh system.

In some embodiments, including any of the foregoing, the BSS includes at least one electrochemical battery.

In some other embodiments, including any of the foregoing, the BSS includes at least one fly wheel.

In some embodiments, including any of the foregoing, the at least one electrochemical battery includes a lithium-ion battery, a lithium-metal solid-state battery, a lead-acid battery, a sodium-ion battery, a sodium-sulfur battery, a lithium-air battery, a zinc-air battery, a zinc-halide battery, a nickel-hydrogen battery, an iron-flow battery, a vanadium-flow battery, or a combination thereof. In some embodiments, including any of the foregoing, the at least one electrochemical battery includes a lithium-ion battery. In some embodiments, including any of the foregoing, the at least one electrochemical battery includes a lithium-metal solid-state battery. In some embodiments, including any of the foregoing, the at least one electrochemical battery includes a lead-acid battery. In some embodiments, including any of the foregoing, the at least one electrochemical battery includes a sodium-ion battery. In some embodiments, including any of the foregoing, the at least one electrochemical battery includes a sodium-sulfur battery. In some embodiments, including any of the foregoing, the at least one electrochemical battery includes a lithium-air battery. In some embodiments, including any of the foregoing, the at least one electrochemical battery includes a zinc-air battery. In some embodiments, including any of the foregoing, the at least one electrochemical battery includes a zinc-halide battery. In some embodiments, including any of the foregoing, the at least one electrochemical battery includes a nickel-hydrogen battery. In some embodiments, including any of the foregoing, the at least one electrochemical battery includes an iron-flow battery. In some embodiments, including any of the foregoing, the at least one electrochemical battery includes a vanadium-flow battery. In some embodiments, including any of the foregoing, the at least one electrochemical battery includes a combination of a lithium-ion battery, a lithium-metal solid-state battery, a lead-acid battery, a sodium-ion battery, a sodium-sulfur battery, a lithium-air battery, a zinc-air battery, a zinc-halide battery, a nickel-hydrogen battery, an iron-flow battery, and a vanadium-flow battery.

In some embodiments, including any of the foregoing, the at least one electrochemical battery includes a sodium ion battery.

In some embodiments, including any of the foregoing, the lithium-ion battery or lithium-metal solid-state battery includes a cathode that includes nickel-manganese-cobalt oxide (NMC), nickel-cobalt-aluminum oxide (NCA), cobalt oxide, manganese oxide, lithium iron phosphate (LFP), lithium iron manganese phosphate (LFMP), lithium titanate (LTO), or a combination thereof. In some embodiments, including any of the foregoing, the lithium-ion battery or lithium-metal solid-state battery includes a cathode that includes nickel-manganese-cobalt oxide (NMC). In some embodiments, including any of the foregoing, the lithium-ion battery or lithium-metal solid-state battery includes a cathode that includes nickel-cobalt-aluminum oxide (NCA). In some embodiments, including any of the foregoing, the lithium-ion battery or lithium-metal solid-state battery includes a cathode that includes cobalt oxide. In some embodiments, including any of the foregoing, the lithium-ion battery or lithium-metal solid-state battery includes a cathode that includes manganese oxide. In some embodiments, including any of the foregoing, the lithium-ion battery or lithium-metal solid-state battery includes a cathode that includes lithium iron phosphate (LFP). In some embodiments, including any of the foregoing, the lithium-ion battery or lithium-metal solid-state battery includes a cathode that includes lithium iron manganese phosphate (LFMP). In some embodiments, including any of the foregoing, the lithium-ion battery or lithium-metal solid-state battery includes a cathode that includes lithium titanate (LTO). In some embodiments, including any of the foregoing, the lithium-ion battery or lithium-metal solid-state battery includes a cathode that includes a combination of nickel-manganese-cobalt oxide (NMC), nickel-cobalt-aluminum oxide (NCA), cobalt oxide, manganese oxide, lithium iron phosphate (LFP), lithium iron manganese phosphate (LFMP), and lithium titanate (LTO).

In some embodiments, including any of the foregoing, the ESS further includes compressed air energy storage, a hydrogen turbine, or a combination thereof. In certain embodiments, the ESS further includes compressed air energy storage. In certain embodiments, the ESS further includes a hydrogen turbine. In some embodiments, including any of the foregoing, the ESS further includes a combination of a compressed air energy storage and a hydrogen turbine. These additional energy storage and power modules would be present in addition to an LDS and BSS as described above.

In some embodiments, including any of the foregoing, the LDS is coupled to a pipeline such that fuel from an external source can flow to the LDS system or such that LDS can produce fuel that flows to an external source. Embodiments of such systems and processes are shown in FIGS. 10-13 and described in the associated description. In FIGS. 10-13, a pipeline could be used to substitute for the trucks, railroad, and shipping that is illustrated.

In some embodiments, including any of the foregoing, the ESS includes at least one storage vessel for storing chemical fuel, for deploying chemical fuel to the rSOC, for exporting to use in applications external to this system, or a combination thereof. In some embodiments, including any of the foregoing, the ESS includes at least one storage vessel for storing chemical fuel. In some embodiments, including any of the foregoing, the ESS includes at least one storage vessel for deploying chemical fuel to the rSOC. In some embodiments, including any of the foregoing, the ESS includes at least one storage vessel for exporting to use in applications external to this system. In some embodiments, including any of the foregoing, the ESS includes at least one storage vessel for storing chemical fuel, for deploying chemical fuel to the rSOC, and for exporting to use in applications external to this system.

In some embodiments, including any of the foregoing, the ESS is configured for the coproduction of, or refueling with, hydrogen (H₂), hydrocarbons, carbon, CO₂, ammonia, methane, methanol, ethanol, formic acid, dimethyl ether, or a combination thereof. In some embodiments, including any of the foregoing, the ESS is configured for the coproduction of, or refueling with, hydrogen (H₂). In some embodiments, including any of the foregoing, the ESS is configured for the coproduction of, or refueling with, hydrocarbons. In some embodiments, including any of the foregoing, the ESS is configured for the coproduction of, or refueling with, carbon. In some embodiments, including any of the foregoing, the ESS is configured for the coproduction of, or refueling with, CO₂. In some embodiments, including any of the foregoing, the ESS is configured for the coproduction of, or refueling with, ammonia. In some embodiments, including any of the foregoing, the ESS is configured for the coproduction of, or refueling with, methane. In some embodiments, including any of the foregoing, the ESS is configured for the coproduction of, or refueling with, methanol. In some embodiments, including any of the foregoing, the ESS is configured for the coproduction of, or refueling with, ethanol. In some embodiments, including any of the foregoing, the ESS is configured for the coproduction of, or refueling with, formic acid. In some embodiments, including any of the foregoing, the ESS is configured for the coproduction of, or refueling with, dimethyl ether. In some embodiments, including any of the foregoing, the ESS is configured for the coproduction of, or refueling with, a combination of hydrogen (H₂), hydrocarbons, carbon, CO₂, ammonia, methane, methanol, ethanol, formic acid, and dimethyl ether.

In some embodiments, including any of the foregoing, the ESS is configured for the coproduction of, or refueling with, hydrogen (H₂), carbon, CO₂, ammonia, methane, methanol, ethane, ethanol, propane, propanol, butane, butanol, gasoline, diesel, jet fuel, formic acid, dimethyl ether, or biogas.

In some embodiments, including any of the foregoing, the ESS is configured with the LDS as an open system such that it charges or discharges using a media stored, or provided, outside the LDS. Embodiments of such open systems that use media stored outside the LDS are shown in FIGS. 10-13 and described in the associated description.

In some embodiments, including any of the foregoing, the chemical fuel is H₂, carbon, a hydrocarbon, CO₂, ammonia, methane, methanol, ethanol, formic acid, dimethyl ether, or a combination thereof. In some embodiments, including any of the foregoing, the chemical fuel is H₂. In some embodiments, including any of the foregoing, the chemical fuel is carbon. In some embodiments, including any of the foregoing, the chemical fuel is a hydrocarbon. In some embodiments, including any of the foregoing, the chemical fuel is CO₂. In some embodiments, including any of the foregoing, the chemical fuel is ammonia. In some embodiments, including any of the foregoing, the chemical fuel is methane. In some embodiments, including any of the foregoing, the chemical fuel is methanol. In some embodiments, including any of the foregoing, the chemical fuel is ethanol. In some embodiments, including any of the foregoing, the chemical fuel is formic acid. In some embodiments, including any of the foregoing, the chemical fuel is dimethyl ether. In some embodiments, including any of the foregoing, the chemical fuel is a combination of H₂, carbon, a hydrocarbon, CO₂, ammonia, methane, methanol, ethanol, formic acid, and dimethyl ether.

In some embodiments, including any of the foregoing, the ESS has an operating power capacity of 1 mega-Watt MW-1 giga-GW. In some embodiments, including any of the foregoing, the ESS has an operating capacity of 1 MW, 2 MW, 3 MW, 4 MW, 5 MW, 6 MW, 7 MW, 8 MW, 9 MW, 10 MW, 11 MW, 12 MW, 13 MW, 14 MW, 15 MW, 16 MW, 17 MW, 18 MW, 19 MW, 20 MW, 21 MW, 22 MW, 23 MW, 24 MW, 25 MW, 26 MW, 27 MW, 28 MW, 29 MW, 30 MW, 31 MW, 32 MW, 33 MW, 34 MW, 35 MW, 36 MW, 37 MW, 38 MW, 39 MW, 40 MW, 41 MW, 42 MW, 43 MW, 44 MW, 45 MW, 46 MW, 47 MW, 48 MW, 49 MW, 50 MW, 51 MW, 52 MW, 53 MW, 54 MW, 55 MW, 56 MW, 57 MW, 58 MW, 59 MW, 60 MW, 61 MW, 62 MW, 63 MW, 64 MW, 65 MW, 66 MW, 67 MW, 68 MW, 69 MW, 70 MW, 71 MW, 72 MW, 73 MW, 74 MW, 75 MW, 76 MW, 77 MW, 78 MW, 79 MW, 80 MW, 81 MW, 82 MW, 83 MW, 84 MW, 85 MW, 86 MW, 87 MW, 88 MW, 89 MW, 90 MW, 91 MW, 92 MW, 93 MW, 94 MW, 95 MW, 96 MW, 97 MW, 98 MW, 99 MW, 100 MW, 150 MW, 200 MW, 250 MW, 300 MW, 350 MW, 400 MW, 450 MW, 500 MW, 550 MW, 600 MW, 650 MW, 700 MW, 750 MW, 800 MW, 850 MW, 900 MW, 950 MW, or 1 GW.

In some embodiments, including any of the foregoing, the ESS has an operating capacity of 60 MW, 10 MW, or 100 kW.

In some embodiments, including any of the foregoing, the ESS includes multiple LDS that each have an operating capacity of at least 10 kW, 100 kW, or a combination thereof. In some embodiments, including any of the foregoing, the ESS includes multiple LDS that each have an operating capacity of at least 10 kW. In some embodiments, including any of the foregoing, the ESS includes multiple LDS that each have an operating capacity of at least 100 KW. In some embodiments, including any of the foregoing, the ESS includes multiple LDS that have a combination of operating capacities of at least 10 kW and 100 kW.

In some embodiments, including any of the foregoing, the ESS has capacity for at least six hours of discharge at a C-rate of 0.0001 to 10.

In some embodiments, including any of the foregoing, the BSS is configured to operate for less than 24 hrs but greater than 15 minutes.

In some embodiments, including any of the foregoing, the BSS is configured to operate for less than 8 hours.

In some embodiments, including any of the foregoing, the LDS is configured to operate for more than 24 hrs.

In some embodiments, including any of the foregoing, the ESS is connected to an electrical grid, a microgrid, a renewable energy generator selected from a solar cell or wind turbine, or a combination thereof. In certain embodiments, the ESS is connected to an electrical grid. In certain embodiments, the ESS is connected to a microgrid. In certain embodiments, the ESS is connected to a renewable energy generator selected from a solar cell. In certain embodiment, the ESS is connected to a renewable energy generator selected from a wind turbine. In some embodiments, including any of the foregoing, the ESS is connected to a combination of an electrical grid, a microgrid, and a renewable energy generator selected from a solar cell or wind turbine. In some embodiments, including any of the foregoing, the ESS is connected to a combination of an electrical grid, a microgrid, and a renewable energy generator selected from a solar cell. In some embodiments, including any of the foregoing, the ESS is connected to a combination of an electrical grid, a microgrid, and a renewable energy generator selected from a wind turbine.

### Methods of Using Energy Storage Systems (ESS)

Set forth herein is a method of using an energy storage system (ESS). The method includes providing a long duration subsystem (LDS) configured for cross-charging with a buffer subsystem (BSS); and at least one processor for controlling series flow, parallel flow, charge C-rates, discharge C-rates, power electronics, or a combination thereof; inputting supply load data, demand load data, ancillary data, or a combination thereof into the at least one processor; and sending instructions from the at least one processor to the LDS, BSS, power electronics, or both, to charge or discharge the LDS, BSS, or both the LDS and BSS.

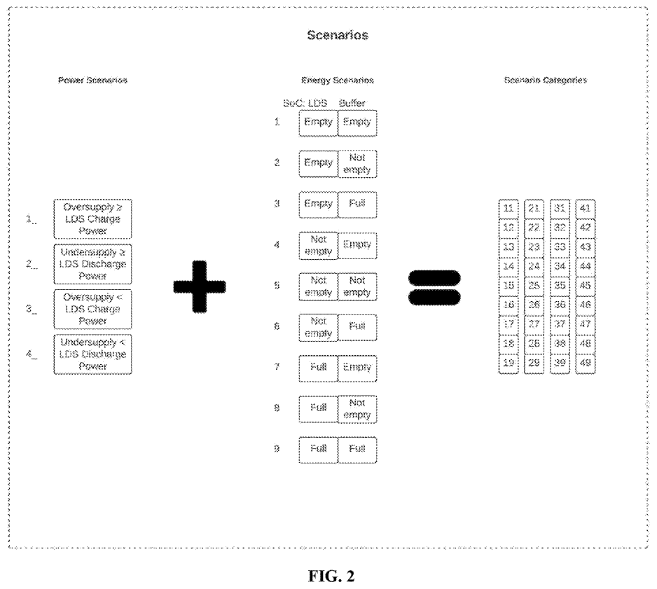

Data that may be communicated to the Decision Maker shown in FIG. 1 includes, but is not limited to, information illustrated in FIG. 2. FIG. 2 is a diagram detailing how a decision maker/controller classifies scenarios based on state of charge, load, and subsystem power capacities.

For example, the Decision Maker may acquire data about Power Scenarios. For example, the external power input may be (1) an oversupply and greater than, or equal to, the LDS Charge Power, (2) the external power input may be an undersupply and greater than, or equal to, the LDS Charge Power, (3) the external power input may be an oversupply and less than the LDS Charge Power, or (4) the external power input may be an undersupply and less than the LDS Charge Power. The Decision Maker may also acquire data about Energy Scenarios. For example, the LDS, the BSS, or both may be empty, i.e., 0% state-of-charge; the LDS, the BSS, or both may be full, i.e., 100% state-of-charge, or the LDS; the BSS, or both may be not empty, i.e., greater than 0% but less than 100% state-of-charge. Energy Scenario (1) is when both the LDS and BSS are empty. Energy Scenario (2) is when the LDS is empty and the BSS is not empty. Energy Scenario (3) is when the LDS is empty and the BSS is full. Energy Scenario (4) is when the LDS is not empty and the BSS is empty. Energy Scenario (5) is when both the LDS and BSS are not empty. Energy Scenario (6) is when the LDS is not empty and the BSS is full. Energy Scenario (7) is when the LDS is full and the BSS is empty. Energy Scenario (8) is when the LDS is full and the BSS is not empty. Energy Scenario (9) is when both the LDS and BSS are full. Each Power Scenario may possibly be paired with each Energy Scenario. These pairings are shown in the Scenario Categories 11 through 49. Scenario 11 means a pairing of Power Scenario (1) with Energy Scenario (1). Scenario 49 means a pairing of Power Scenario (4) with Energy Scenario (9).

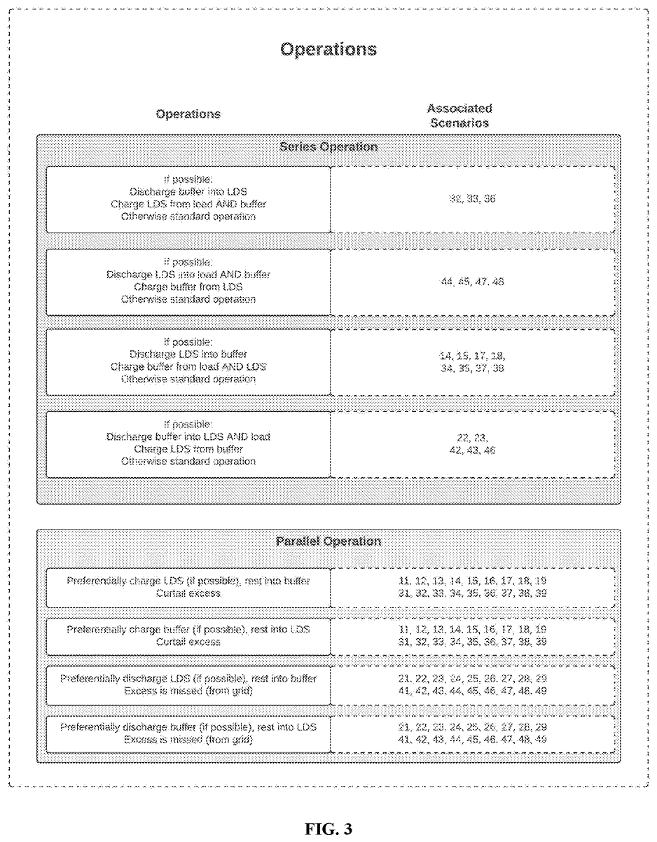

FIG. 3 shows how a decision maker may use the classified scenarios in FIG. 2 to determine an operating mode. The operating modes may be Series Operation or in Parallel Operation. For example, in scenarios 32, 33, and 36, during series operation, if possible, the operating mode is to discharge the BSS into the LDS, charge the LDS from the oversupply load and from the BSS, or otherwise maintain standard operations. Alternatively, in scenarios 11, 12, 13, 14, 15, 16, 17, 18, 19, 31, 32, 33, 34, 35, 36, 37, 38, or 39, during parallel operation, the operating mode is to preferentially charge the LDS, if possible, and then charge the BSS to curtail excess oversupply; or preferentially charge the BSS, if possible, and then charge the LDS to curtain excess oversupply.

In FIG. 3, for scenarios 44, 45, 47, or 48, during series operation, the operating mode is, if possible, to discharge the LDS into the load and into the BSS, charge the BSS from the LDS, or otherwise maintain standard operations. For scenarios 14, 15, 17, 18, 34, 35, 37, or 38, during series operation, the operating mode is, if possible, to discharge the LDS into the BSS, charge the BSS from the load and LDS, or otherwise maintain standard operation. For scenarios 22, 23, 42, 43, or 46, during series operation, the operating mode is, if possible, to discharge the BSS into the LDS and into the load, charge the LDS from the BSS, or otherwise maintain standard operation.

In FIG. 3, for scenarios 21, 22, 23, 24, 25, 26, 27, 28, 29, 41, 42, 43, 44, 45, 46, 47, 48, or 49, in parallel operation, the operating mode is, if possible, to preferentially discharge the LDS, if possible, and then the BSS with the excess if missed being supplied by the grid; or preferentially discharge the BSS, if possible, and then the LDS with the excess if missed being supplied by the grid.

Additional ancillary data may be supplied for the Decision Maker, or at least one processor, to analyze. For example, ancillary data may include forecasted data about upcoming energy load supplies and demand. This may be a forecast for the next few minutes, or the next few hours, or for the next few days, weeks, or months.

For example, the at least one processor may include a forecaster that can predict upcoming energy loads (supply and demand) a day or more in advance.

In certain embodiments, the decision-making controller decides which subsystem to operate and whether to operate in parallel or in series based on current energy load, forecasted energy load, state-of-charge of each subsystem, power capacity of each subsystem, and subsystem-specific characteristics. These subsystem-specific characteristics include, but are not limited to, ramp rate, self-discharge rate, and round-trip efficiency.

The aforementioned features allow a system that can be sized and operated flexibly to meet energy supply and demand loads of different geographies and applications in a cost-effective manner. These potential applications include microgrid applications, consumer and industrial energy backup, electrical grid services/support, residential energy storage, and long-haul transportation.

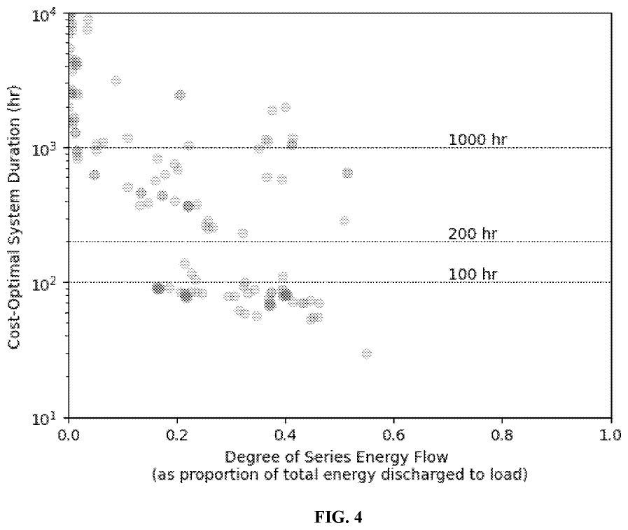

For example, FIG. 4 shows cost-optimal system duration compiled over several optimizations with varying conditions. The varying conditions included location, supply load, demand load, system size restrictions, system efficiencies, and control logic. Each datapoint represents an islanded microgrid system where demand is completely met with solar energy generation and an LDS-plus-buffer system set forth in this disclosure such as the system shown in FIG. 1. While all durations below 1,000 hours are technologically feasible with any amount of series energy flow, the cost-optimal solution trends toward smaller durations the more that series operation is utilized. This figure was prepared by performing several optimization simulations where a time-series energy demand profile was fixed at various different levels based on the application that each optimization was targeting. The size of a photovoltaic (PV) array and the power and energy capacities of the LDS and buffer subsystems were allowed to vary to meet net demand. Time-series energy generation profiles were computed from insolation data at a location with a simulated solar panel having no tracking, 35° tilt, and 180° azimuth. The constraint in each optimization was that all demand had to be met by photovoltaic (PV) supply or energy dispatched by the energy storage system (LDS and buffer) at each timestep throughout the year, and the goal of each optimization was to achieve the lowest system cost possible (where the capital expense of each component was set for an individual optimization). The agent/decision maker dictated operation and the direction of energy flow. Several different decision-making algorithms, e.g., the algorithms used for FIGS. 2 and 3, that dictated operation based on load, subsystem power capacities, and subsystem energy capacities were included in this plot, allowing varying levels of series energy flow (cross-charging). Several different locations were included.

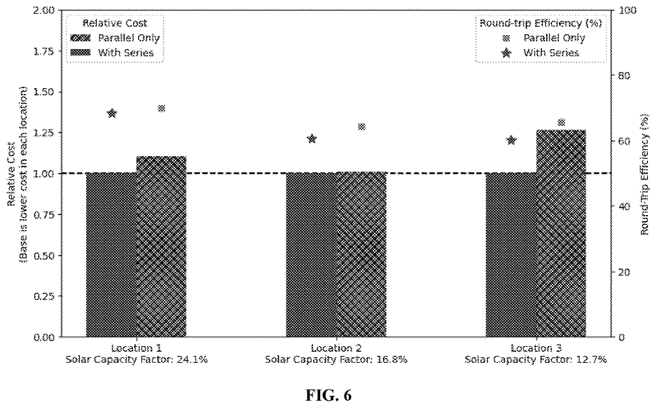

FIG. 6 demonstrates the tradeoff between system cost (left axis) and round-trip efficiency (RTE, right axis) when implementing series charging into a control scheme. Simulations were run across a variety of locations in different climates. By implementing series operation into the control scheme (in comparison with only parallel operating modes), optimal system size achieves a lower cost. However, series operation imparts a slight efficiency loss, represented by lower round-trip efficiency. “Solar capacity factor” is used as a proxy for climate, where warmer climates are represented by a higher capacity factor. “Capacity factor” here is measured by solar irradiance captured by a simulated solar panel with no tracking, 35° tilt, and 180° azimuth. This is a shorthand to quantify climate and geographical area. This figure was prepared by performing several optimizations (as described in FIG. 4) at various locations, where the decision maker both allowed and didn't allow series energy flow. RTE was quantified by computing total energy dispatched by the LDS and buffer system as a proportion of the total energy charged into it.

In some embodiments, including any of the foregoing, the ESS is any ESS set forth in this disclosure.

In some embodiments, including any of the foregoing, the methods include sending instructions from the at least one processor for series flow between the LDS and BS; or for parallel energy flow in the LDS and BSS. In some embodiments, including any of the foregoing, the methods includes sending instructions from the at least one processor according to any one of the operating modes in FIG. 3. As used herein, the at least one processor includes the Decision Maker in FIG. 1.

In some embodiments, including any of the foregoing, the ancillary data comprises forecasting data, price signals, or a combination thereof. In some embodiments, including any of the foregoing, the ancillary data comprises forecasting data. In some embodiments, including any of the foregoing, the ancillary data comprises price signals. In some embodiments, including any of the foregoing, the ancillary data comprises a combination of forecasting data and price signals.

In some embodiments, including any of the foregoing, the method includes sending instructions from the at least one processor according to the scenario categories in FIGS. 2 and 3.

In some embodiments, including any of the foregoing, the method includes sending instructions from the at least one processor to coproduce chemical fuel. This includes using an rSOC in electrolyzer mode to consume electricity and generate a chemical fuel. That fuel may be stored internally within the closed system or may be stored externally in a storage tank or fuel truck, or transmitted in a pipeline.

In some embodiments, including any of the foregoing, the chemical fuel is hydrogen (H₂), at least one hydrocarbon, carbon, CO₂, ammonia, methane, methanol, ethanol, formic acid, dimethyl ether, or a combination thereof. In some embodiments, including any of the foregoing, the chemical fuel is hydrogen (H₂). In some embodiments, including any of the foregoing, the chemical fuel is at least one hydrocarbon. In some embodiments, including any of the foregoing, the chemical fuel is carbon. In some embodiments, including any of the foregoing, the chemical fuel is CO₂. In some embodiments, including any of the foregoing, the chemical fuel is ammonia. In some embodiments, including any of the foregoing, the chemical fuel is methane. In some embodiments, including any of the foregoing, the chemical fuel is methanol. In some embodiments, including any of the foregoing, the chemical fuel is ethanol. In some embodiments, including any of the foregoing, the chemical fuel is formic acid. In some embodiments, including any of the foregoing, the chemical fuel is dimethyl ether. In some embodiments, including any of the foregoing, the chemical fuel is a combination of hydrogen (H₂), at least one hydrocarbon, carbon, CO₂, ammonia, methane, methanol, ethanol, formic acid, and dimethyl ether.

In some embodiments, including any of the foregoing, the chemical fuel is hydrogen (H₂), carbon, CO₂, ammonia, methane, methanol, ethane, ethanol, propane, propanol, butane, butanol, gasoline, diesel, jet fuel, formic acid, dimethyl ether, or biogas. In some embodiments, including any of the foregoing, the chemical fuel is hydrogen (H₂). In some embodiments, including any of the foregoing, the chemical fuel is carbon. In some embodiments, including any of the foregoing, the chemical fuel is CO₂. In some embodiments, including any of the foregoing, the chemical fuel is ammonia. In some embodiments, including any of the foregoing, the chemical fuel is methane. In some embodiments, including any of the foregoing, the chemical fuel is methanol. In some embodiments, including any of the foregoing, the chemical fuel is ethane. In some embodiments, including any of the foregoing, the chemical fuel is ethanol. In some embodiments, including any of the foregoing, the chemical fuel is propane. In some embodiments, including any of the foregoing, the chemical fuel is propanol. In some embodiments, including any of the foregoing, the chemical fuel is butane. In some embodiments, including any of the foregoing, the chemical fuel is butanol. In some embodiments, including any of the foregoing, the chemical fuel is gasoline. In some embodiments, including any of the foregoing, the chemical fuel is diesel. In some embodiments, including any of the foregoing, the chemical fuel is jet fuel. In some embodiments, including any of the foregoing, the chemical fuel is formic acid. In some embodiments, including any of the foregoing, the chemical fuel is dimethyl ether. In some embodiments, including any of the foregoing, the chemical fuel is biogas. In some embodiments, including any of the foregoing, the chemical fuel is a combination of hydrogen (H₂), carbon, CO₂, ammonia, methane, methanol, ethane, ethanol, propane, propanol, butane, butanol, gasoline, diesel, jet fuel, formic acid, dimethyl ether, and biogas.

In some embodiments, including any of the foregoing, the at least one processor uses a control algorithm that operates the LDS for a specific amount of time to minimize idling and operates the BSS to fill in gaps between LDS operation and the load.

The ESS set forth herein are based on the combination of multiple modular subsystems. In this way, the ESS has a variety of ways it can be constructed or modularized. For example, the LDS component can include several different power modules. In some embodiments, including any of the foregoing, each of these power modules can be operated independently. When multiple power modules operate together, the total LDS power is the sum of the operating modules. In certain of these embodiments, a control algorithm minimizes idling. The control algorithm allows for the power to be readily scaled up or down. For example, if an LDS included ten modules, then two modules out of the ten could operate if the demand is 20% of the total LDS power capacity. In certain embodiments, each rSOC subsystem is able to scale power up and down easily. This allows balance of systems (BOS) components such as compressors, blowers, storage tanks, and other BOS components to be combined with less economic penalty since all the components won't have to be operational at full scale all the time. This also allows for greater flexibility in how the LDS is built and deployed. This allows for greater flexibility in the geometric shape and size that the LDS can be built to achieve. In one embodiment, an LDS could include two 100 kW modules instead of one 1 MW module and still achieve the same power output.

In some embodiments, including any of the foregoing, the method includes providing a net charge power profile as in FIG. 9 by discharging one or more LDS and one or more BSS in the ESS.

### Location Shifting

Set forth herein are long duration energy storage installations in which at least two distinct geographic locations share the production and consumption of charged media that is stored and transported between locations. In some embodiments, there are two geographic locations. In other embodiments, there are more than two geographic locations. In other embodiments, there are 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100, geographic locations that share the production and consumption of charged media that is stored and transported therebetween. These systems and processes of storing and moving energy allow for the shift in energy generated in a production-site to be converted to electricity in a consumption-site. In some of these embodiments, one production installation services multiple consumption installations.

Multiple long duration energy storage systems, such as those set forth herein, can operate together as a fleet. For example, one long duration energy storage system can operate in an area of excess renewables availability and produce a lot of excess fuel. This excess fuel can then be shipped to another site, for example one with a lot of geographic constraints that fit a lot of storage and/or renewable power generation. In some of these embodiments, one geographic location doesn't have sufficient renewable energy resources, such as, but not limited to, places far North on the planet such as Canada or Northern Europe; or places with limited geographic area, such as but not limited to Japan, dense cities, and/or islands. By networking places that have sufficient renewable energy resources with places that don't, the instant disclosure solves an energy production and consumption problem.

In certain embodiments, including any of the foregoing, the recipient site can transport the discharge media (generated from the spent fuel) back to the initial site, thereby creating a system (or network) of multiple units that operates, on net, as a closed loop.

In some embodiments, two or more closed system long duration energy storage installations can operate as standalone sites. Each site is capable of producing, storing, consuming, or any combination thereof, charged media such as fuel for a solid oxide fuel cell (SOFC) or reversible solid oxide cell (RSOC) system. However, in certain embodiments, these closed systems can switch from being a closed system to being an open system and thereby transfer charged and/or discharged media between them. In some embodiments, charged and/or discharged media is transferred between systems to make up for one or more media or renewable energy generating capacity deficiencies. This network of closed energy storage systems that can operate as a network of open systems is distinct from other energy storage systems that only operate as open systems, such as generators (e.g., natural gas turbines, SOFC systems, diesel gensets, etc.). The network of closed systems contemplated herein can include systems that switch periodically to open systems to transfer energy between different geographic locations.

In some embodiments, including any of the foregoing, two or more energy production and or consumption installations operate together in which at least one installation is an energy producing site that includes a solid-oxide electrolyzer and at least one other installation is an energy consuming site that includes at least one solid-oxide fuel cell. In certain of these embodiments, the solid-oxide electrolyzer and solid-oxide fuel cell are not reversible and only operate in one mode-either electrolyzer mode or fuel cell mode.

In some embodiments, including any of the foregoing, the fuel produced at an energy production installation is not a fuel for a solid-oxide electrolyzer cell. In some embodiments, including any of the foregoing, the fuel consumed at an energy consumption installation is not a fuel for a solid-oxide fuel cell.

In some other embodiments, including any of the foregoing, the fuel produced at an energy production installation is a fuel for a solid-oxide electrolyzer cell. In some other embodiments, including any of the foregoing, the fuel consumed at an energy consumption installation is a fuel for a solid-oxide fuel cell.

In some embodiments, including any of the foregoing, each energy production site, energy consumption site, or both, doesn't have to operate exclusively as energy production or consumption. For example, each energy production site, energy consumption site, or both can operate independently as a closed-system battery and/or switch between consumption and production depending on conditions, such as but not limited to, seasonality, unexpected events like outages, increased city development, and other related conditions. In these examples, the energy production site, the energy consumption site, or both can optionally switch to consumption, and consumption back to production, depending on a variety of factors and conditions.

In certain embodiments, an energy production site can generate energy using imported and/or cheap external fuel of different kinds. In some embodiments, the external fuel is a hydrocarbon or oxy-hydrocarbon. In certain embodiments, an energy consumption site can consume imported, cheap, or both, external fuel of different kinds.

Because some of the systems contemplated herein capture the CO₂ generated at the electricity-production site during consumption processes, CO₂ can be transported back to the fuel-production site to be repurposed as more fuel, sold, up-cycled to other products, or any combination thereof. In certain embodiments, CO₂ can be transported back to the fuel-production site to be repurposed as more fuel. In certain embodiments, CO₂ can be transported back to the fuel-production site to be sold. In certain embodiments, CO₂ can be transported back to the fuel-production site to be up-cycled to other products. In certain embodiments, CO₂ can be transported back to the fuel-production site to be repurposed as a combination of more fuel, sold, up-cycled to other products.

The installations contemplated here can be set up overtime. For example, a consumption-site can set up a battery system to do closed-system operations by connecting to an electrical grid and/or any existing on-site renewables. Then, that same installation can start receiving shipments later on when a supply-line is established.

The long duration energy storage and/or battery systems contemplated herein can operate as a “closed system”, an “open system”, or both during operation.

In some embodiments, including any of the foregoing, the long duration energy storage and/or battery systems will charge and discharge energy, storing all chemicals it produces in the process.

In some embodiments, including any of the foregoing, the long duration energy storage and/or battery systems will produce excess chemicals that can be taken out of the system and used externally (“coproduction”) or take in excess chemicals/fuels for an additional energy source (“refueling”). Note that these “coproduced”/“refueled” chemicals do not have to be the same as the chemicals being stored in a given long duration energy storage and/or battery systems' charge/discharge tanks.

In some embodiments, including any of the foregoing, multiple the long duration energy storage and/or battery systems can operate together as a fleet. For example, one system can operate in an area of excess renewables availability and produce a lot of excess fuel. This can then be shipped to another site, for example one with a lot of geographic constraints that fit a lot of storage and/or renewable power generation.

Importantly, the recipient site can transport the discharge media (generated from the spent fuel) back to the initial site, create a system of multiple units that operates, on net, as a closed loop.

In some embodiments, including any of the foregoing, the sizing between two sites (energy production and consumption) is such that it is advantageous to oversize components for excess production at one site so that it can be shipped and used in a recipient site. A variety of sizing combinations are contemplated herein that are unique from the sizing requirements in which an installation operates independently and outside of an energy transportation network.

In some embodiments, including any of the foregoing, fuel does not have to be imported from another system or given to another system. For example, fuel can be bought from commercial sources and/or sold to commercial sources in some embodiments.

In some embodiments, including any of the foregoing, an rSOC system can be deployed and only operated as a standalone system, and later a production site can be built and incorporated into the initial site's operation. This would form a network of sites.

In some embodiments, including any of the foregoing, the rSOC system can be deployed but only operated as a single-direction SOFC with fuel tanks imported from another site. This would allow the initial rSOC system to gradually add components to operate as a standalone system.

In some embodiments, including any of the foregoing, the network of sites is not limited to two sites/systems. Multiple sites/systems can work together as a fleet, with a universal optimum sizing and are contemplated herein.

In some embodiments, including any of the foregoing, the systems and processes contemplated herein move energy between islands/land sites.

In some embodiments, including any of the foregoing, the systems and processes contemplated herein move energy between geographic locations that have different renewable energy capacities.

In some embodiments, including any of the foregoing, the systems and processes contemplated herein move energy between cities and rural areas. In some embodiments, including any of the foregoing, the systems and processes contemplated herein move energy between suburbs and rural areas. In some embodiments, including any of the foregoing, the systems and processes contemplated herein move energy between rural areas and dense cities. In some embodiments, including any of the foregoing, the systems and processes contemplated herein move energy between locations on mountainous areas and areas near or in a desert.

In some embodiments, including any of the foregoing, the systems and processes contemplated herein allow for selling renewable energy from areas of higher availability and/or low demand (e.g., the middle of the country) to areas of higher demand and more intermittency (e.g., the coasts, where there are larger cities).

In some embodiments, including any of the foregoing, the systems and processes contemplated herein allow for generating electricity in the areas of abundant renewables (e.g., the middle of the country) and finding areas with more price favorability, then selling it there.

In some embodiments, including any of the foregoing, the systems and processes contemplated herein include coproduction from one site, and transportation of the coproduced charge media to a secondary site that is a discharge only site. In some of these embodiments, the discharge-only system would be lower cost, but different system than the energy charge site.

In some embodiments, including any of the foregoing, the systems and processes contemplated herein include coproduction from one site, and transportation of the coproduced charge media to a secondary site that is a refueling site. In some of these embodiments, the discharge-only system would be lower cost, but different system than the energy charge site.

In some embodiments, including any of the foregoing, the systems and processes contemplated herein coproduction from one site that is operating in a charge only mode, and transportation to a second site that is operating is discharge only mode.

In some embodiments, including any of the foregoing, the methods and system herein include production from a charge-only site, and transportation of the produced charged media to another site that is possibly operating in discharge-only mode.

In some embodiments, including any of the foregoing, the systems and processes contemplated herein include a recipient site that can be a battery that does peak shaving, and gets excess fuel from regular shipments.

FIG. 10 shows an embodiment of long duration energy storage at two or more locations. In FIG. 10, there are at least two distinct geographic locations. One geographic location is labeled 1001. Another geographic location is labeled 1009. Site 1 (1001) is a geographic location with excess renewable energy capacity. Site 2 (1009) is a geographic location with limited renewable energy capacity. Production site 1, (1001) having excess renewables, is capable of producing excess stored charge media that is shipped out to consumption site 2 (1009). Site 2 (1009) has limited/insufficient renewables (solar/wind), and takes excess fuel from site 1 (1001). Site 2 then stores discharge media, and transports it back to site 1 for reconversion into charge media. As one example, site 1 (1001) has at least two wind farms (1002) and at least three solar farms (1003). These wind farms (1002) and solar farms (1003) generate electricity from the wind and sun, respectively. This electricity from the wind farms (1002) and solar farms (1003) can be used to power a building 1005. This electricity can also be used at a production facility (1004) to generate charge media and store it at 1004. The charge media store at 1004 can be used when the wind farms (1002) and solar farms (1003) are not generating electricity to power the building (1005). However, because of the excess renewable energy, the stored charged media at 1004 can also be transported by way of trucks (1006), railroad (1007), or ship (1008) to a consumption site (1012). At the consumption site (1012), the charge media produced at 1004 can be discharged at 1012 to power a building (1013). The consumption site may also have capabilities to produce and store charge media using wind farms (1010) and/or solar farms (1011). However, in this example, there is more energy generating capacity in wind farms (1002) and solar farms (1003) than in wind farms (1010) and solar farms (1011). The distance traveled by trucks (1006), railroad (1007), and/or shipments (1008) can be short distances of one mile to several hundreds of miles. The distance traveled by trucks (1006), railroad (1007), and/or shipments (1008) can be long distances of several hundreds of miles to one or several thousands of miles. The discharge media produced at consumption site 1012 can in some embodiments be transported back to production site 1004 to be transformed into more charge media that can be stored at 1004 and or transported by trucks (1006), railroad (1007), and/or ship (1008) back to consumption site 1012. In some embodiments, site 1 (1001) has lots of geographic space for solar and wind and optionally has the ability to draw electricity from an electrical grid. In some embodiments, site 2 (1009) has no or limited geographic space for solar and wind and optionally has the ability to draw electricity from an electrical grid. In some embodiments, the charge media is a liquid or gas fuel. In some embodiments, the discharge media is CO₂.

In FIG. 10, energy tanks are shown that can be imported/offloaded from an RSOC system. In some embodiments, these systems can switch from being a closed system to an open system.

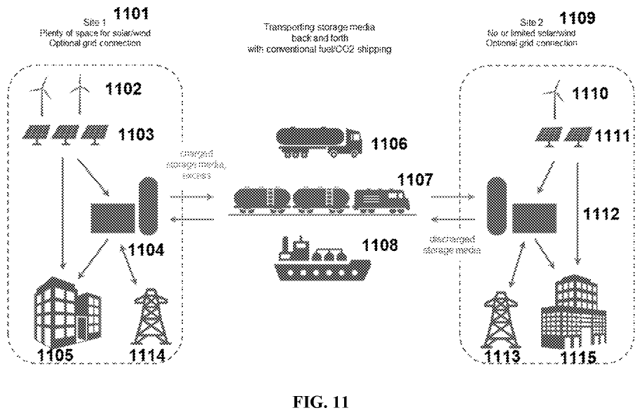

FIG. 11 shows an embodiment of long duration energy storage at two or more locations in which both locations are grid-connected. In FIG. 11, there are at least two distinct geographic locations. One geographic location is labeled 1101. Another geographic location is labeled 1109. Site 1 (1101) is a geographic location with excess renewable energy capacity. Site 2 (1109) is a geographic location with limited renewable energy capacity. Both Site 1 (1101) and Site 2 (1109) are connected to an electrical grid at 1114 and 1113, respectively. Production site 1, (1101) having excess renewables and a grid connection, is capable of producing excess stored charge media that is shipped out to consumption site 2 (1109). Site 2 (1109) has limited/insufficient renewables (solar/wind) albeit also grid-connected, and takes excess fuel from site 1 (1101). Site 2 (1109) then stores discharge media, and transports it back to site 1 (1101) for reconversion into charge media. As one example, site 1 (1101) has at least two wind farms (1102) and at least three solar farms (1103). These wind farms (1102) and solar farms (1103) generate electricity from the wind and sun, respectively. This electricity from the wind farms (1102) and solar farms (1103), as well as from the grid (1114) can be used to power a building 1105 or supply electricity to the grid (1114). This electricity can also be used at a production facility (1104) to generate charge media and store it at 1104. The charge media store at 1104 can be used when the wind farms (1102) and solar farms (1103) are not generating electricity to power the building (1105) or the grid (1114). However, because of the excess renewable energy, the stored charged media at 1104 can also be transported by way of trucks (1106), railroad (1107), or ship (1108) to a consumption site (1112). At the consumption site (1112), the charge media produced at 1104 can be discharged at 1112 to power a building (1115) or supply electricity to the grid (1113). The consumption site may also have capabilities to produce and store charge media using wind farms (1110) and/or solar farms (1111). However, in this example, there is more energy generating capacity in wind farms (1102) and solar farms (1103) than in wind farms (1110) and solar farms (1111). The distance traveled by trucks (1106), railroad (1107), and/or ship (1108) can be short distances of one mile to several hundreds of miles. The distance traveled by trucks (1106), railroad (1107), and/or ship (1108) can be long distances of several hundreds of miles to one or several thousands of miles. The discharge media produced at consumption site 1112 can in some embodiments be transported back to production site 1104 to be transformed into more charge media that can be stored at 1104 and or transported by trucks (1106), railroad (1107), and/or ship (1108) back to consumption site 1112. In some embodiments, site 1 (1101) has lots of geographic space for solar and wind and optionally has the ability to draw electricity from an electrical grid. In some embodiments, site 2 (1109) has no or limited geographic space for solar and wind and optionally has the ability to draw electricity from an electrical grid. In some embodiments, the charge media is a liquid or gas fuel. In some embodiments, the discharge media is CO₂.

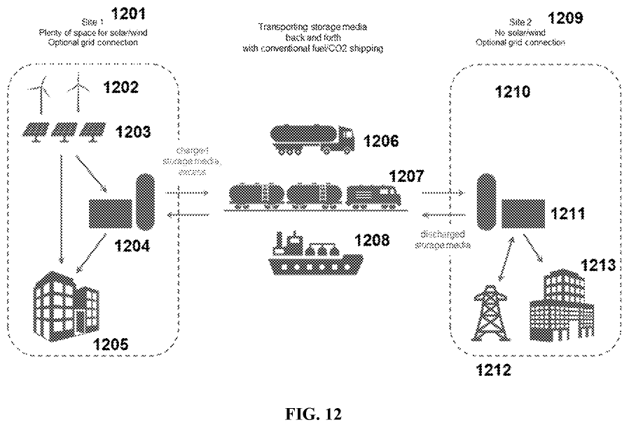

FIG. 12 is an illustration of an embodiment of long duration energy storage location shifting between two geographic locations, one of which has renewable energy generating capacity and the other location does not but is grid-connected. In FIG. 12, there are at least two distinct geographic locations. One geographic location is labeled 1201. Another geographic location is labeled 1209. Site 1 (1201) is a geographic location with excess renewable energy capacity. Site 2 (1209) is a geographic location with no renewable energy capacity (1210). Site 2 (1209) is connected to an electrical grid at 1212. Production site 1, (1201) having excess renewables is capable of producing excess stored charge media that is shipped out to consumption site 2 (1211). Site 2 (1209) has no renewables (solar/wind) albeit also grid-connected (1212) and takes excess fuel from site 1 (1201). Site 2 (1209) then stores discharge media at 1211 and transports it back to site 1 (1201) for reconversion into charge media. As one example, site 1 (1201) has at least two wind farms (1202) and at least three solar farms (1203). These wind farms (1202) and solar farms (1203) generate electricity from the wind and sun, respectively. This electricity from the wind farms (1202) and solar farms (1203) can be used to power a building 1205. This electricity can also be used at a production facility (1204) to generate charge media and store it at 1204. The charge media store at 1204 can be used when the wind farms (1202) and solar farms (1203) are not generating electricity to power the building (1205). However, because of the excess renewable energy, the stored charged media at 1204 can also be transported by way of trucks (1206), railroad (1207), or ship (1208) to a consumption site (1211). At the consumption site (1211), the charge media produced at 1204 can be discharged at 1211 to power a building (1213) or supply electricity to the grid (1212). The distance traveled by trucks (1206), railroad (1207), and/or ship (1208) can be short distances of one mile to several hundreds of miles. The distance traveled by trucks (1206), railroad (1207), and/or ship (1208) can be long distances of several hundreds of miles to one or several thousands of miles. The discharge media produced at consumption site 1211 can in some embodiments be transported back to production site 1204 to be transformed into more charge media that can be stored at 1204 and or transported by trucks (1206), railroad (1207), and/or ship (1208) back to consumption site 1211. In some embodiments, site 1 (1201) has lots of geographic space for solar and wind and optionally has the ability to draw electricity from an electrical grid. In some embodiments, site 2 (1209) has no or limited geographic space for solar and wind and optionally has the ability to draw electricity from an electrical grid. In some embodiments, the charge media is a liquid or gas fuel. In some embodiments, the discharge media is CO₂.

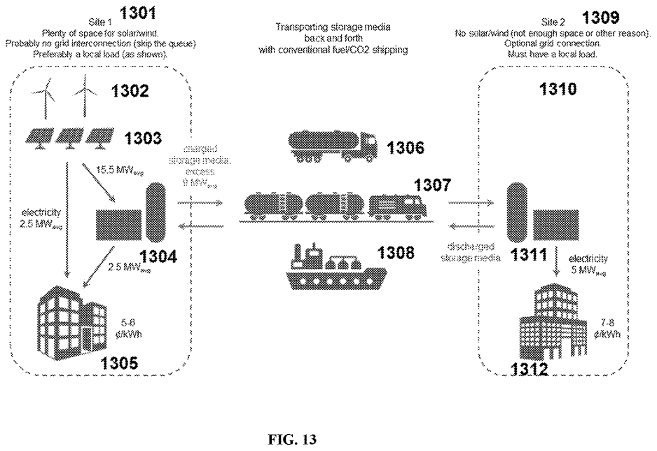

FIG. 13 is an illustration of an embodiment of long duration energy storage location shifting between two geographic locations one of which has renewable energy generating capacity and the other location does not. In FIG. 13, there are at least two distinct geographic locations. One geographic location is labeled 1301. Another geographic location is labeled 1309. Site 1 (1301) is a geographic location with excess renewable energy capacity. Site 2 (1309) is a geographic location with no renewable energy capacity (1310). Production site 1, (1301) having excess renewables is capable of producing excess stored charge media that is shipped out to consumption site 2 (1311). Site 2 (1309) has no renewables (solar/wind) and takes excess fuel from site 1 (1301). Site 2 (1309) then stores discharge media at 1311 and transports it back to site 1 (1301) for reconversion into charge media. As one example, site 1 (1301) has at least two wind farms (1302) and at least three solar farms (1303). These wind farms (1302) and solar farms (1303) generate electricity from the wind and sun, respectively. This electricity from the wind farms (1302) and solar farms (1303) can be used to power a building 1305. This electricity can also be used at a production facility (1304) to generate charge media and store it at 1304. The charge media stored at 1304 can be used when the wind farms (1302) and solar farms (1303) are not generating electricity to power the building (1305). However, because of the excess renewable energy, the stored charged media at 1304 can also be transported by way of trucks (1306), railroad (1307), or ship (1308) to a consumption site (1311). At the consumption site (1311), the charge media produced at 1304 can be discharged at 1311 to power a building (1312). The distance traveled by trucks (1306), railroad (1307), and/or ship (1308) can be short distances of one mile to several hundreds of miles. The distance traveled by trucks (1306), railroad (1307), and/or ship (1308) can be long distances of several hundreds of miles to one or several thousands of miles. The discharge media produced at consumption site 1311 can in some embodiments be transported back to production site 1304 to be transformed into more charge media that can be stored at 1304 and or transported by trucks (1306), railroad (1307), and/or ship (1308) back to consumption site 1311. In some embodiments, site 1 (1301) has lots of geographic space for solar and wind. In some embodiments, site 2 (1309) has no or limited geographic space for solar and wind. In some embodiments, the charge media is a liquid or gas fuel. In some embodiments, the discharge media is CO₂. FIG. 13 also provides some numbers for approximating the magnitude of electricity and/or energy generated, stored, and consumed. For example, the solar and wind may generate approximately 15.5 MW, on average, of electricity that can be used at production site 1304. The solar and wind may also directly provide 2.5 MW, on average, electricity to the building 1305. When the production site 1304 discharges stored charge media it can then provide, on average, approximately 2.5 MW of electricity to the building 1305. In some embodiments, about 9 MW, on average, of charged storage media can be transported by truck, railroad, or ship, to the consumption site 1311, which can then discharge the transported stored charge media and provide about 5 MW, on average, of electricity to a building, 1312. In this example, the cost of electricity consumption at building 1305 is about 5-6 cents per kWh. In this example, the cost of electricity consumption at building 1312 is about 7-8 cents per kWh. The cost is higher at building 1312 on account of the transportation costs.

In some embodiments, including any of the foregoing, the fuels produced include, but are not limited to, CH₃OH, CH₄, a liquid organic hydrogen carrier (e.g., methylcyclohexane), or a combination thereof. In certain embodiments, the fuel is CH₃OH. In certain embodiments, the fuel is CH₄. In certain embodiments, the fuel is a liquid organic hydrogen carrier. In some of these embodiments, the fuel is produced in a high resource area, an area with low seasonal variation, or a combination thereof. For example, fuels may be produced in Australia and sent to Japan, South Korea, Hawaii, or a combination thereof. In other examples, fuels may be produced in the central or southern United States of America (e.g., Texas, Oklahoma) and sent to areas in the United States other than the central or southern United States of America. In other examples, fuels may be produced in the central or southern United States of America (e.g., Texas, Oklahoma) and sent to Japan, South Korea, Hawaii, or a combination thereof. For example, fuels may be produced in the Middle East and sent to Japan, South Korea, Hawaii, or a combination thereof. In other examples, fuels may be produced in the Middle East and sent to areas in the United States. In some of these embodiments, the recipients of the fuels are located in areas with high seasonality, e.g., islands, or space-constrained areas like cities.

### EXAMPLES

### Example 1—Simulated Comparison of an Energy Storage System (ESS) Having Long Duration Subsystems (LDS) with an ESS Having Both an LDS and a Buffer Subsystem (BSS) and the Ability to Coproduce H₂

FIG. 8 shows an example in which the combination of a rSOC LDS with a BSS results in a higher c/d_{avg} and c/dₚₖ than would be possible with just an rSOC LDS or a BSS individually. This can result in a higher state-of-charge over the same comparative time periods than an ESS with just an LDS or BSS individually. This state of charge in the LDS can be exported from the system and act as coproduced fuel (the export was not shown graphically). The following data is simulated data.

In FIG. 8, each column represents a different system; the top row represents time-series operation of each system to meet demand. Positive numbers on the y-axis represent generation, load, or energy dispatch while negative numbers on the same y-axis represent battery charging. The bottom row represents state-of-charge of the energy storage system, i.e., ESS. Each system has demand being met both directly from the supply of solar radiation and through the ESS. The primary energy storage system in each is an rSOC-based flow battery (“rSOC” stands for “reversible solid oxide cell”) LDS subsystem. The left and middle columns have no buffer subsystems, i.e., BSS units. The rightmost column has additional buffer subsystems. The rSOC subsystem in each column was calculated based on a H₂/H₂O solid oxide cell fuel system operating at 600° C.-800° C. and the buffer subsystem was based on a lithium-ion battery with typical round-trip efficiency (RTE). The rSOC operating voltages were maintained at levels typical of a H₂/H₂O fuel system and at temperature levels that would avoid excessive degradation.

In each column, demand level (i.e., load) is flat in each case and decreases between each case (left to right). Demand is shown as the flat orange bar. In the left column, the demand is around 0.25 kW. In the middle column, the demand is around 0.15 kW. In the right column, demand is about 0.1 kW.

The blue line represents solar generated energy. From time zero hours until 7 hours, no sun is shining and the blue line is at zero on the y-axis. Around 7 hours, the sun rises and the blue curve rises too and reaches a maximum generation of energy around 12 hours. When the sun is shining, electricity is generated in solar cells. That generated electricity is used to meet demand and also charge the LDS by coproducing H₂ fuel. The coproduced H₂ fuel can be used in the rSOC, when the sun is not shining or not shining sufficiently, in addition to the internally stored rSOC fuel. The sun begins to set after hour 12 and solar energy generation decreases until about hour 17 when the sun finally sets and solar energy generation returns to zero on the y-axis.

The first column contains a system with an rSOC LDS but no buffer i.e., BSS, and that operates at an average charge-to-discharge (c/d) ratio of 2.4 (3.5 peak) with minimal-to-no coproduction. As the sun shines, the LDS charges and demand is met. No H₂ fuel is coproduced in an appreciable amount.

The second column operates with an rSOC LDS but without a buffer, i.e., BSS. The rSOC LDS operates at a c/d_{avg} ratio of 4.2 and c/dₚₖ of 5.7. These c/d ratios are unique to rSOC systems, particularly compared to systems like electrochemical batteries, and are dictated primarily by thermodynamics and material constraints.

Co-production of H₂ fuel is seen in the bottom graph of the second column (bottom-center). This is shown as a higher state-of-charge compared to the bottom left plot. The bottom row is a plot of state-of-charge as a function of time. The difference between the starting value and ending value on the y-axis is the amount of H₂ fuel co-produced and stored in excess storage vessels. The co-production of H₂ fuel results in a higher state-of-charge around hour 17 in the bottom center plot compared to the bottom right plot. In the bottom left plot, the LDS is charging from the solar radiation. But in the bottom middle plot, the LDS is charging and coproducing H₂ fuel. This higher state-of-charge in the middle column compared to the left column is because the co-produced H₂ is stored in an external tank and that storage represents additional energy in the ESS. This is because the H₂ can be used as a fuel in a fuel cell to provide additional energy when the sun is not shining. While the sun was shining, starting at hour 7 and lasting until hour 17, the LDS was charging, and electricity was being supplied to meet the demand. However, in the middle column, coproduction of H₂ fuel was also occurring and resulted in a greater amount of energy stored in the middle column compared to the left column. Coproduction was not occurring, or not occurring at an appreciable rate, in the bottom left plot.

The third column has an ESS with an rSOC LDS and a BSS. The third column ESS uses a buffer subsystem, i.e., BSS, to supplement the rSOC LDS. This allows the system to operate with a net c/d_{avg} of 5.7 (the peak value in the second column) and a c/dₚₖ of 8.9. The buffer subsystem, i.e., BSS, allows this operation through cross-charging, in which the rSOC-based LDS subsystem still operates with a c/d_{avg} and c/dₚₖ of 4.2 and 5.7, respectively, but the BSS can also be charged to capture excess discharge from the rSOC-subsystem. The charged BSS can later discharge energy when the sun is not shining and supplement the energy provided by the LDS, which can be supplied using internally stored reactants (e.g., C and CO₂) or externally stored fuel, e.g., H₂. The far right column configuration allows a far greater amount of co-production, seen in the bottom-right graph, by allowing the system as a whole to operate at a far greater c/d_{avg} and c/dₚₖ than conventional rSOC systems or other types of LDS systems.

FIG. 8 shows that, in a given day, solar radiation can be used to charge an LDS. If the LDS has a sufficiently high c/d_{avg} and c/dₚₖ, as in the middle column, the rSOC LDS can also be used to coproduce fuel that can be externally stored. And if a BSS is paired with an rSOC LDS, as in the far right column, the c/d_{avg} and c/dₚₖ are even higher and the BSS can be charged and fuel can be coproduced. The high c/d_{avg} and c/dₚₖ results in an ESS in the far right column that has a higher round trip efficiency than the left or middle column systems. The high c/d_{avg} and c/dₚₖ results in an ESS in the far right column that is more cost effective than the left or middle column systems.

When the sun's incident radiation begins to decrease after hour 12, or sets around hour 17, the LDS can discharge energy to meet demand and accommodate the loss of electricity that was being provided by solar radiation. The BSS can supplement this energy to provide a smooth power curve. This is why the state-of-charge in the bottom right remains the highest towards the end of the day compared to the left column or the middle column. When the sun is not shining, the LDS can discharge to meet load demands and the BSS can supplement the demand as needed.

### Example 2—Parallel Operation Compared with Series Operation

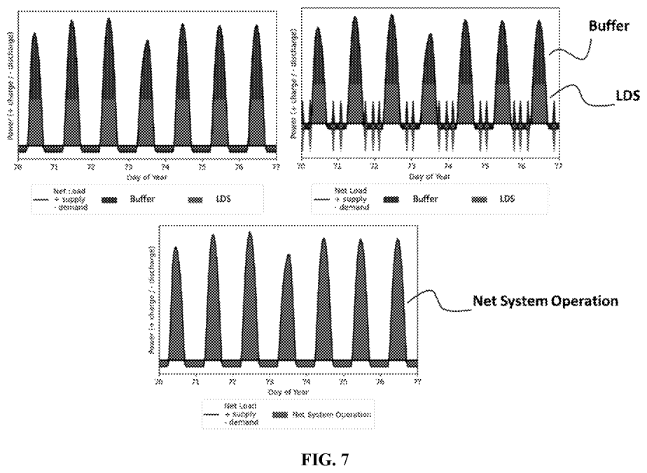

FIG. 7 displays systems meeting a set net load. The difference between solar supply (positive) and demand (negative) is displayed in FIG. 7 using only parallel operation (top left) and with the option of series operation (top right). The results in FIG. 7 are simulated.

Both cases meet the same load and both have the same net system operation (bottom). FIG. 7 was prepared by performing individual time-series simulations (in a manner similar to the optimizations described in FIG. 4, without varying sizes to meet a cost-optimum). FIG. 7 shows energy discharged by the LDS and BSS individually to meet demand unmet by solar generation, and energy charged into the subsystems, as well as net system operation (LDS operation+buffer operation). For FIG. 7, the decision maker operation varied to both allow and forbid series energy flow.

### Example 3—Net Charge Power Profile Provided by an Ess Having an LDS and BSS

FIG. 9 shows an ESS having eight rSOC LDS and a BSS. The data in FIG. 9 is simulated data.

The simulated system has multiple BSS power modules with the LDS units that provide buffer operation. There are eight power systems (labelled “RSOC system”). The red line is a representative charge profile throughout an example day. A control algorithm operates each subsystem for a specific amount of time to minimize idling. The buffer subsystems, i.e., the multiple power modules, fill in gaps between LDS operation and the load.

The red line is a representative charge profile throughout an example day. A control algorithm operates each subsystem for a specific amount of time to minimize idling. The buffer subsystems, i.e., the multiple power modules, fill in gaps between LDS operation and the load.

Around hour 6, shown on the x-axis, the sun begins to shine and generates electricity in a solar panel. In this simulated Example, the sun shines for a total of 15 hours. This is indicated on the x-axis. The first rSOC LDS is charged for 9 of these 15 hours. The second and third rSOC LDS are charged for 11 of these 15 hours. The sixth and seventh rSOC LDS are charged for 12 of these 15 hours. The eighth rSOC LDS is charged for 9 of these 15 hours.

Because the LDS has a lower C-rate than the BSS, the charge profile of the LDS is not smooth. There are gaps between the red curve and the charge profile of the eight LDS units. The BSS fills in these gaps by accepting charge so the net charge profile is a smooth curve.

On the right side of FIG. 9, the percent of the units idling is indicated. This data shows that this percentage is minimized using a control algorithm that allows the BSS units to fill in the charge profile gaps between the net charge curve and the step-wise changes in the charge profile for the LDS units.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1. An energy storage system (ESS), comprising:
a long duration subsystem (LDS) configured for cross-charging with a buffer subsystem (BSS); and
at least one processor for controlling series flow, parallel flow, charge C-rates, discharge C-rates, power electronics, or a combination thereof;
wherein the ESS has a charge-to-discharge power ratio (c/d) of 1 to 10.

2. The ESS of claim 1, wherein the ESS has an average charge-to-discharge power ratio (c/d_{avg}) of 1 to 10.

3. The ESS of claim 1 or 2, wherein the ESS has a peak charge-to-discharge power ratio (c/dₚₖ) of 1 to 10.

4. The ESS of any one of claims 2-3, wherein the LDS, BSS, or both, have an c/d_{avg} ratio of 1 to 10.

5. The ESS of any one of claims 3-4, wherein the LDS, BSS, or both, have a c/dₚₖ ratio of 1 to 10.

6. The ESS of any one of claims 2-5, wherein the LDS, BSS, or both, have an c/d_{avg} ratio of 3 to 6.

7. The ESS of any one of claims 1-6, wherein the LDS:BSS energy capacity ratio is 1:1 to 100:1; or 1:1000 to 1:1; or 1:1000 to 100:1.

8. The ESS of any one of claims 1-7, wherein the ESS has an LDS:BSS energy capacity ratio is 8:1 or higher.

9. The ESS of claim 8, wherein the LDS:BSS energy capacity ratio is less than 1000:1.

10. The ESS of any one of claims 1-9, wherein the LDS operates at a lower C-rate than the BSS.

11. The ESS of any one of claims 1-10, wherein the LDS comprises a reversible solid-oxide electrochemical cells (rSOC) flow battery, nickel-hydrogen battery, an iron flow battery, a vanadium flow battery, or a combination thereof.

12. The ESS of any one of claims 1-13, wherein the LDS is coupled to a storage tank and configured to operate as at least one flow battery.

13. The ESS of any one of claims 1-12, wherein the LDS is coupled to a delivered fuel source, a fuel truck, or a combination thereof, and configured to operate as at least one flow battery.

14. The ESS of any one of claims 10-16, wherein the LDS is configured to operate for 20-50 hours.

15. The ESS of any one of claims 10-14, wherein the at least one rSOC flow battery comprises a carbon-chemistry system, a hydrogen-chemistry system, a carbon-hydrogen-chemistry system, an ammonia-chemistry system, an iron-chemistry system, or a combination thereof.

16. The ESS of claim 15, wherein the carbon-hydrogen-chemistry system is configured to use as fuel, or generate as a product, alcohols, hydrocarbons, or a combination thereof.

17. The ESS of claim 16, wherein the hydrocarbons are selected from aromatic hydrocarbons saturated alicyclic hydrocarbon, or a combination thereof.

18. The ESS of any one of claims 1-17, comprising different sized power modules and energy modules.

19. The ESS of any one of claims 1-18, wherein the LDS comprises power modules and energy modules configured to operate collectively.

20. The ESS of any one of claims 1-20, wherein the LDS comprises at least one power component and at least one energy component.

21. The ESS of claim 20, wherein the size of the power component and the energy component are different.

22. The ESS of any one of claims 1-21, wherein the ESS is a 150 KW system.

23. The ESS of claim 22, wherein the ESS comprises a 50 kW module and a 100 kW module.

24. The ESS of any one of claims 1-26, wherein the BSS comprises at least one electrochemical battery.

25. The ESS of claim 24, wherein the at least one electrochemical battery comprises a lithium-ion battery, lithium-metal solid-state battery, a lead-acid battery, a sodium-ion battery, a sodium-sulfur battery, a lithium-air battery, a zinc-air battery, a zinc-halide battery, a nickel-hydrogen battery, an iron-flow battery, a vanadium-flow battery, or a combination thereof.

26. The ESS of claim 25, wherein the lithium-ion battery or lithium-metal solid-state battery comprises a cathode that comprises nickel-manganese-cobalt oxide (NMC), nickel-cobalt-aluminum oxide (NCA), cobalt oxide, manganese oxide, lithium iron phosphate (LFP), lithium iron manganese phosphate (LFMP), lithium titanate (LTO), or a combination thereof.

27. The ESS of any one of claims 1-25, further comprising compressed air energy storage, a hydrogen turbine, or a combination thereof.

28. The ESS of any one of claims 1-27, wherein the LDS is coupled to a pipeline such that fuel from an external source can flow to the LDS system or such that LDS can produce fuel that flows to an external source.

29. The ESS of any one of claims 1-27, comprising at least one storage vessel for storing chemical fuel, for deploying chemical fuel to the rSOC, for exporting to use in applications external to this system, or a combination thereof.

30. The ESS of any one of claims 1-29, wherein the ESS is configured for the coproduction of, or refueling with, hydrogen (H₂), hydrocarbons, carbon, CO₂, ammonia, methane, methanol, ethanol, formic acid, dimethyl ether, or a combination thereof.

31. The ESS of any one of claims 1-30, wherein the ESS is configured with the LDS as an open system such that it charges or discharges using a media stored, or provided, outside the LDS.

32. The ESS of any one of claims 29-31, wherein the chemical fuel is H₂, carbon, a hydrocarbon, CO₂, ammonia, methane, methanol, ethanol, formic acid, dimethyl ether, or a combination thereof.

33. The ESS of any one of claims 1-32, wherein the ESS has an operating capacity of 1 MW-1 GW.

34. The ESS of any one of claims 1-33, wherein the ESS has an operating capacity of 60 MW, 10 MW, or 100 kW.

35. The ESS of any one of claims 1-34, wherein the ESS comprises multiple LDS that each have an operating capacity of at least 10 kW, 100 KW, or a combination thereof.

36. The ESS of any one of claims 1-35, wherein the ESS has capacity for at least six hours of discharge at a C-rate of 0.0001 to 10.

37. The ESS of any one of claims 1-36, wherein the BSS is configured to operate for less than 24 hrs but greater than 15 minutes.

38. The ESS of claim 37, wherein the BSS is configured to operate for less than 8 hours.

39. The ESS of any one of claims 1-38, wherein the LDS is configured to operate for more than 24 hrs.

40. The ESS of any one of claims 1-39, wherein the ESS is connected to an electrical grid, a microgrid, a renewable energy generator selected from a solar cell or wind turbine, or a combination thereof.

41. A method of using an energy storage system (ESS), comprising
providing a long duration subsystem (LDS) configured for cross-charging with a buffer subsystem (BSS); and at least one processor for controlling series flow, parallel flow, charge C-rates, discharge C-rates, power electronics, or a combination thereof;
inputting supply load data, demand load data, ancillary data, or a combination thereof into the at least one processor; and
sending instructions from the at least one processor to the LDS, BSS, power electronics, or both, to charge or discharge the LDS, BSS, or both the LDS and BSS.

42. The method of claim 41, wherein the ESS is the ESS of any one of claims 1-43.

43. The method of claim 41 or 42, comprising sending instructions from the at least one processor for series flow between the LDS and BS; or for parallel energy flow in the LDS and BSS.

44. The method of any one of claims 41-43, wherein the ancillary data comprises forecasting data, price signals, or a combination thereof.

45. The method of any one of claims 41-44, comprising sending instructions from the at least one processor according to the scenario categories in FIG. 2.

46. The method of any one of claims 41-45, comprising sending instructions from the at least one processor according to the operations and associated scenario in FIG. 3.

47. The method of any one of claims 41-46, comprising sending instructions from the at least one processor to produce chemical fuel.

48. The method of claim 47, wherein the chemical fuel is hydrogen (H₂), at least one hydrocarbon, carbon, CO₂, ammonia, methane, methanol, ethanol, formic acid, dimethyl ether, or a combination thereof.

49. The method of any one of claims 41-48, wherein the at least one processor uses a control algorithm that operates the LDS for a specific amount of time to minimize idling and operates the BSS to fill in gaps between LDS operation and the load.

50. The method of any one of claims 41-49, comprising providing a net charge power profile as in FIG. 9 by discharging one or more LDS and one or more BSS in the ESS.

51. An energy storage network (ESN), comprising:
at least two energy storage systems (ESS); and configured to:
(a) transport charge media between the at least two ESS;
(b) transport discharge media between the at least two ESS; or
(c) a combination of (a) and (b).

52. The ESN of claim 51, wherein at least one ESS is a long duration subsystem (LDS) configured for cross-charging with a buffer subsystem (BSS).

53. The ESN of claim 55, wherein at least one ESS has a charge-to-discharge power ratio (c/d) of 1 to 10.

54. The ESN of any one of claims 51-55, further comprising at least one processor for controlling series flow, parallel flow, charge C-rates, discharge C-rates, power electronics, or a combination thereof;

55. The ESN of any one of claims 51-54, wherein the at least two ESS are coupled to a delivered fuel source, a fuel truck, or a combination thereof, and configured to operate as at least one flow battery.

56. The ESN of any one of claims 51-57, wherein the at least two ESS are linked via a roadway, railroad, shipping lane, or a combination thereof.

57. The ESN of any one of claims 51-56, wherein at least one ESS is connected to an electrical grid, a building, or a combination thereof.

58. The ESN of any one of claims 51-57, wherein all ESS are connected to an electrical grid, a building, or a combination thereof.

59. The ESN of any one of claims 51-58, wherein no ESS is connected to an electrical grid, a building, or a combination thereof.

60. The ESN of any one of claims 51-59, wherein the at least two ESS are located at least one mile from each other.

61. The ESN of any one of claims 51-59, wherein the at least two ESS are located at least one hundred miles from each other.

62. The ESN of any one of claims 51-59, wherein the at least two ESS are located at least one thousand mile from each other.

63. The ESN of any one of claims 51-62, wherein at least one ESS has an average charge-to-discharge power ratio (c/d_{avg}) of 1 to 10.

64. The ESN of any one of claims 54-63, wherein at least one ESS has a peak charge-to-discharge power ratio (c/dₚₖ) of 1 to 10.

65. The ESN of any one of claims 52-64, wherein at least one LDS, BSS, or both, in an ESS have an c/d_{avg} ratio of 1 to 10.

66. The ESN of any one of claims 52-65, wherein at least one LDS, BSS, or both, in an ESS have a c/dₚₖ ratio of 1 to 10.

67. The ESN of any one of claims 52-66, wherein at least one LDS, BSS, or both, in an ESS have an c/d_{avg} ratio of 3 to 6.

68. The ESN of any one of claims 52-67, wherein at least one LDS, BSS, or both, in an ESS have a c/dₚₖ ratio of 4 to 6 or a c/dₚₖ ratio of 7 to 10.

69. The ESN of any one of claims 52-68, wherein at least one ESS has a c/d_{avg} that is about 5.7.

70. The ESN of any one of claims 52-69, wherein at least one ESS has a c/dₚₖ that is about 8.9.

71. The ESN of any one of claims 52-70, wherein at least one LDS:BSS in an ESS has an energy capacity ratio is 1:1 to 100:1.

72. The ESN of any one of claims 52-71, wherein at least one LDS:BSS in an ESS has an energy capacity ratio is 8:1 or higher.

73. The ESN of any one of claims 52-72, wherein at least one LDS:BSS in an ESS has an energy capacity ratio is less than 1000:1.

74. The ESN of any one of claims 52-73, wherein at least one LDS in an ESS operates at a lower C-rate than the BSS.

75. The ESN of any one of claims 52-74, wherein at least one LDS in an ESS comprises a rSOC flow battery, nickel-hydrogen battery, an iron flow battery, a vanadium flow battery, or a combination thereof.

76. The ESN of any one of claims 52-75, wherein at least one LDS in an ESS is coupled to a storage tank and configured to operate as at least one flow battery.

77. The ESN of any one of claims 52-76, wherein at least one LDS in an ESS is configured to operate for 20-50 hours.

78. The ESN of any one of claims 75-77, wherein the at least one rSOC flow battery comprises a carbon-chemistry system, a hydrogen-chemistry system, a carbon-hydrogen-chemistry system, an ammonia-chemistry system, an iron-chemistry system, or a combination thereof.

79. The ESN of claim 78, wherein the carbon-hydrogen-chemistry system is configured to use as fuel, or generate as a product, alcohols, hydrocarbons, or a combination thereof.

80. The ESN of claim 79, wherein the hydrocarbons are selected from aromatic hydrocarbons saturated alicyclic hydrocarbon, or a combination thereof.

81. The ESN of any one of claims 51-80, comprising different sized power modules and energy modules.

82. The ESN of any one of claims 52-81, wherein at least one LDS in an ESS comprises power modules and energy modules configured to operate collectively.

83. The ESN of any one of claims 52-81, wherein at least one LDS in an ESS comprises at least one power component and at least one energy component.

84. The ESN of claim 83, wherein the size of the power component and the energy component are different.

85. The ESN of any one of claims 51-84, wherein at least one ESS is a 150 KW system; a 150 kW or greater system; a 300 kW system; a 300 kW or greater system; a 500 kW system; a 500 kW or greater system; a 1 MW system; or a 1 MW or greater system.

86. The ESN of claim 85, wherein at least one ESS comprises a 50 kW module and a 100 KW module.

87. The ESN of any one of claims 52-86, wherein at least one BSS in an ESS comprises at least one electrochemical battery.

88. The ESN of claim 87, wherein the at least one electrochemical battery comprises a lithium-ion battery, lithium-metal solid-state battery, a lead-acid battery, a sodium-ion battery, a sodium-sulfur battery, a lithium-air battery, a zinc-air battery, a zinc-halide battery, a nickel-hydrogen battery, an iron-flow battery, a vanadium-flow battery, or a combination thereof.

89. The ESN of claim 88, wherein the lithium-ion battery or lithium-metal solid-state battery comprises a cathode that comprises nickel-manganese-cobalt oxide (NMC), nickel-cobalt-aluminum oxide (NCA), cobalt oxide, manganese oxide, lithium iron phosphate (LFP), lithium iron manganese phosphate (LFMP), lithium titanate (LTO), or a combination thereof.

90. The ESN of any one of claims 52-89, wherein at least one LDS in an ESS is coupled to a pipeline such that fuel from an external source can flow to the LDS system or such that LDS can produce fuel that flows to an external source.

91. The ESN of any one of claims 52-90, wherein at least ESS is configured for storing chemical fuel, for deploying chemical fuel to the rSOC, for exporting to use in applications external to this system, or a combination thereof.

92. The ESN of any one of claims 51-91, wherein at least one ESS is configured for the coproduction of, or refueling with, hydrogen (H₂), hydrocarbons, carbon, CO₂, ammonia, methane, methanol, ethanol, formic acid, dimethyl ether, or a combination thereof.

93. The ESN of any one of claims 51-91, wherein at least one ESS is configured with an LDS as an open system such that it charges or discharges using a media stored, or provided, outside the LDS.

94. The ESN of any one of claims 91-93, wherein the chemical fuel is H₂, carbon, a hydrocarbon, CO₂, ammonia, methane, methanol, ethanol, formic acid, dimethyl ether, or a combination thereof.

95. A method of using an energy storage system (ESS), comprising
providing an ESN of any one of claims 54-97; and
(a) transporting charge media between the at least two ESS;
(b) transporting discharge media between the at least two ESS; or
(c) a combination of (a) and (b).
